(19) United States
(12) Patent Application Publication
(10) Pub. No.: US 2022/0366277 A1
(43) Pub. Date: Nov. 17, 2022

(54) AUTOMATIC GENERATIVE LEARNED PROCESS COACHING

(71) Applicant: The Fin Exploration Company, San Francisco, CA (US)

(72) Inventors: Alec DeFilippo, Syracuse, NY (US); Michael Richter, Atherton, CA (US)

(21) Appl. No.: 17/320,024

(22) Filed: May 13, 2021

(51) Int. Cl. G06N 5/04; G06N 20/00

(52) U.S. Cl. CPC G06N 5/04; G06N 20/00

(57) ABSTRACT

Methods, systems, and apparatus, including computer programs encoded on computer storage media, for automatic generative learned process coaching. One of the methods includes receiving interaction data for a user for interactions occurring in multiple software services used by the user during handling of a case. A case type of the case is determined and a machine learning model that includes learned model interaction behavior for the case type is identified. Interaction data for the user is compared to the learned model interaction behavior for the case type. Action data is generated for the user that includes an interaction behavior improvement recommendation that is determined based on the comparing of the interaction data for the user to the learned model interaction behavior for the case type. Action is taken based on the action data.

### BACKGROUND

### Technical Field

This specification relates to automatic generative learned process coaching.

### Background

Computer users often multitask, doing multiple things at once. A computer user may be a customer support agent who may split their time across multiple cases, such as to provide support to customers phoning in or using a chat box to obtain support. The customer support representative may spend different portions of time helping each of the customers. The customer support representative may also perform other actions on the computer that are not related to any of the customers' cases.

### SUMMARY

This specification describes technologies for automatic generative learned process coaching. Automatic generative learned-process coaching can involve a machine-learning engine that uses a learned model to train users to do the right process based on learned best processes. Automatic generative learned-process coaching can include tracking operator behaviors within their digital environment and comparing the operator's behaviors to learned best behaviors or to a prescribed expected set of input behaviors or outcome results for given tasks. Personalized recommendations for improved behavior can be generated for the operator based on analyzing the operator's current behavior. The personalized recommendations can be presented to the operator in real time to direct and improve operator behavior.

In general, one innovative aspect of the subject matter described in this specification can be embodied in methods that include the actions of: receiving interaction data for a user for interactions occurring in multiple software services used by the user during handling of a case; determining a case type of the case; identifying a machine learning model that includes learned model interaction behavior for the case type; comparing interaction data for the user to the learned model interaction behavior for the case type; generating action data for the user, wherein the action data comprises an interaction behavior improvement recommendation that is determined based on the comparing of the interaction data for the user to the learned model interaction behavior for the case type; and taking action based on the action data.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Automatic generative learned process coaching can enable activity tracking across a variety of digital workspaces (e.g., web pages, external applications, etc.) rather than only within a given system. Relevant and personalized recommendations can be generated for an operator's task at hand in contrast to a limited set of pre-defined articles that may be available in a learning management or knowledge-base system. The automatic generative learned process coaching system can automatically maintain and curate content used for recommendations and actions, in contrast to other systems that are manually curated. With automatic generative learned process coaching, sub-optimal behavior can be prevented and learned improved behavior can be reinforced. Improved interactions can be performed based on automatic recommendation or automatic action performance, rather than relying on unguided operator decision making. Operators can self-direct personal and learning engine improvement using a generative learning feedback loop. Automatic generative learned process coaching can be continuously used by an operator in contrast to manual coaching which consumes and relies on availability and affordability of a human coach.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example of a workforce analytics system that can be used to determine discrete time spent by customer service agents on different tasks across different systems and produce reports based on discretized time, according to some implementations of the present disclosure.

FIG. 1B shows an example of a workforce analytics manager (WAM), according to some implementations of the present disclosure.

FIG. 2 is a screenshot of a customer screen for handling cases in the workforce analytics system 100, according to some implementations of the present disclosure.

FIG. 3 is a screen shot of an example of a search analytics page for looking up customer service agent events, according to some implementations of the present disclosure.

FIG. 4 is a screen shot of an example of a dashboard for customer service agent time spent on cases, according to some implementations of the present disclosure.

FIG. 5 is a screen shot of an example of a focus events structure, according to some implementations of the present disclosure.

FIGS. 6A-6B are screen shots collectively showing an example of a true utilization page, according to some implementations of the present disclosure.

FIGS. 7A-7B are screen shots collectively showing an example of a true handle time page, according to some implementations of the present disclosure.

FIGS. 8A-8B are screen shots collectively showing an example of an outliers page, according to some implementations of the present disclosure.

FIG. 9 is a screen shot of an example of a customer service agent summary page, according to some implementations of the present disclosure.

FIG. 10A is a screen shot of an example of a process flow diagram, according to some implementations of the present disclosure.

FIG. 10B is a screen shot of an example of a process timeline, according to some implementations of the present disclosure.

FIG. 11 is a screen shot of an example of a resource analysis page, according to some implementations of the present disclosure.

FIG. 12 is a screen shot of an example of a trigger event definition page, according to some implementations of the present disclosure.

FIG. 13 is a screen shot of an example of a clickstream page, according to some implementations of the present disclosure.

FIG. 14A is a screen shot of an example of a case defining services per organization page, according to some implementations of the present disclosure.

FIG. 14B is a screen shot showing an example of a document object model (DOM) tools page, according to some implementations of the present disclosure.

FIG. 14C is a screen shot showing an example of an add DOM fingerprint page, according to some implementations of the present disclosure.

FIG. 15 is a flowchart of an example of a method for determining time spent by the customer service agent on the particular case, according to some implementations of the present disclosure.

FIG. 16 is a flowchart of a method for insight analysis.

FIG. 17A is a block diagram illustrating an environment that includes a learned coaching engine.

FIG. 17B is a flowchart of a method for determining a learned coaching action to perform using a machine learning engine.

FIG. 17C illustrates an example of performing learned coaching actions determined by a machine learning engine.

FIG. 18A is a diagram of the components of an exemplary system for automatic generative learned process coaching in a digital environment.

FIG. 18B illustrates example interaction patterns.

FIG. 19 is a flowchart of a method for automatic generative learned process coaching in a digital environment.

FIG. 20 is a block diagram of an example computer system used to provide computational functionalities associated with described algorithms, methods, functions, processes, flows, and procedures described in the present disclosure.

Like reference numbers and designations in the various drawings indicate like elements.

### DETAILED DESCRIPTION

Human operators or agents can perform various digital tasks during a work day. For example, a customer service representative may use various applications when providing customer service to a customer for a particular customer service case. Different types of cases may generally be handled in different ways. Certain processes or sequences of interactions may often be performed for a particular case type, for example. However, processes and order of operations to perform tasks can change over time. Or, as another example, a particular operator may not have learned or been trained on particular processes or a recommend order of operations of tasks. Changing and unlearned procedures can create a challenge for organizations with regards to continuously disseminating new information and training operators on new and changing information.

Existing solutions for training operators can include providing operators access to learning management systems and knowledge bases and/or manual shadowing and coaching of operators. Learning management system and knowledge-base approaches can have various disadvantages. For example, an operator may not know how to use a learning management system or knowledge base to search for and identify resources needed for a particular task. As another example, underlying resources of a learning management system or knowledge base (e.g., articles, guides, etc.) may require manual review and updating by human curator(s), which can result in human and material resource expense as well as delays to procedural updates. Additionally, updates to a common learning management system or knowledge base are generalized updates that are common to all operators but not tailored to a given operator for enabling the operator to maximize utility of the underlying resource.

Manual shadowing and coaching approaches can suffer from a limited amount of time available for sessions between the operator and the coach. Furthermore, a coach may not think to mention or discuss all aspects of the operator's workflow or procedures. Accordingly, coaching approaches can result in a discussion of only a subset of procedures that may be beneficial for an operator. Additionally, manual coaching can result in substantial costs of employee time since coach-based training involves time of both the operator and coach.

Learning management system, knowledge-base, and shadow-based coaching approaches can be referred to as deterministic, top-down approaches. As an alternative to deterministic, top-down approaches, automatic generative, learned-process coaching can be performed. Automatic generative learned-process coaching can involve a machine-learning engine that uses a learned model to train users to perform a recommended process that been determined, for example, based on the learned processes of best operators and best outcomes. Automatic generative learned-process coaching can include tracking operator behaviors within their digital environment and comparing the operator's behaviors to the behaviors of the same individual and/or other individuals performing similar tasks over time or to a prescribed expected set of input behaviors or outcome results for given tasks. Analyzing the operator's current behavior can include identifying potential task types the operator may be performing, analyzing current and historical operator behavior for data patterns, comparing current operator behavior to prior operator behavior data for same or similar task types or to prescribed recommended behavior.

Personalized recommendations for improved behavior can be generated for the operator based on analyzing the operator's current behavior. The personalized recommendations can be presented to the operator in real time to direct operator behavior, after-the-fact as a review of coaching opportunities, or automatically used as input to automated systems which will perform actions on behalf of the operator. The personalized recommendations can take the form of written, verbal, or symbolic instruction sets comprised of a variety of actions.

Automatic generative learned-processing coaching can enable frequent and timely (e.g., in some cases near-instantaneous, such as within one second of a trigger event) operator training. Additionally, the personalized, just-in-time training can be more relevant and effective than other approaches, resulting in improved education, action direction, coaching, and learning mechanisms. Furthermore, automatic generative learned-processing coaching can result in improved operator experiences and improved personal or business process execution, which can lead to additional downstream benefits for the organization.

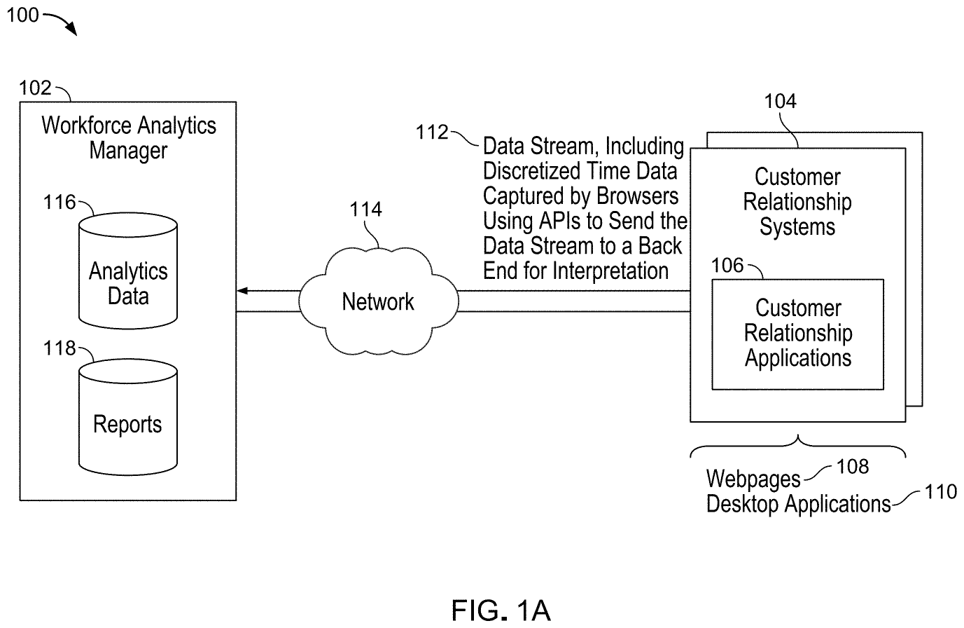

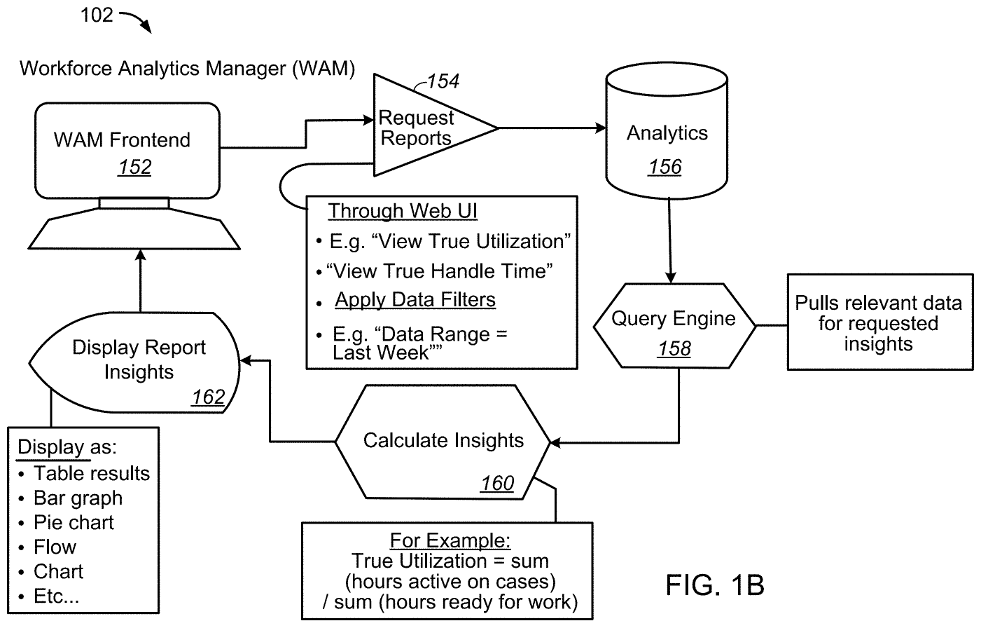

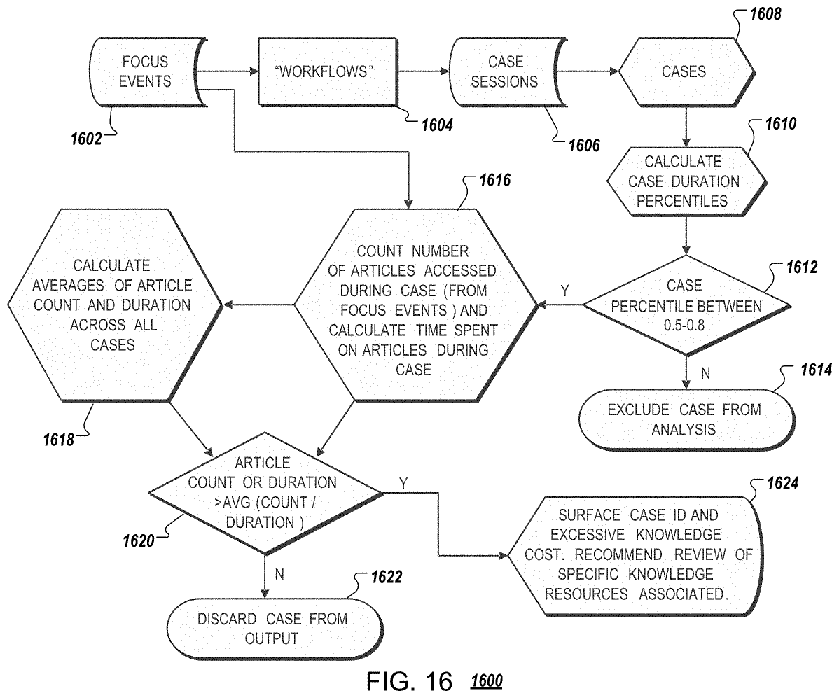

Further details and advantages of the true utilization approach are described below. For example, FIGS. 1-15 provide details regarding a workforce analytics manager for recording and managing interactions. FIGS. 16-19 provide additional details regarding learned process coaching.

The following detailed description describes techniques for discretizing time spent by users (e.g., customer service agents) doing specific tasks on computers. These technologies generally involve associating identifiers (IDs) from different systems while users spend time handling a case spanning multiple pages and applications of the different systems. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure can be used to assign each user action to a single “case” that a customer service agent is working on when the customer service agent is working simultaneously on more than one case. For example, the customer service agent can be a customer representative agent that handles Customer Relationship Management (CRM) cases that arrive at a CRM system by phone call, chat session, or online portal.

In some implementations, discretizing time can include setting identifier threshold rules, so as to define finer-grain criteria used to identify events that count as being associated with a case. Rules can also be used to define and access a set of identifiers used in set of systems that are to be tracked. Techniques of the present disclosure can be used to disregard time spent associated with identifiers that are not included in a tracked subset of systems to be tracked. Moreover, techniques of the present disclosure can be used to disregard identifiers corresponding to events that last less than a threshold event duration. Doing so can provide the benefit of avoiding an interruption of a current count of work being discretized.

Identifiers from multiple systems can be linked by observing an expected behavioral pattern of a user, such as a customer support agent. As an example, the system can determine that customer support agents generally follow a certain workflow on a given case. The identifiers used in the different systems that are accessed during the workflow can be linked together even if their linkage was previously unknown. For example, a chat application (or app) for chatting with customers may have a chat ID which is used as the case ID of the case. In a new chat, the customer support agent may use their own internal CRM system where they look up the customer. The internal CRM system may have a completely different set of identifiers, different from the chat app. If it is known that the customer support agent is always going to look up the customer in a certain amount of time after getting a new customer chat request, then the identifiers can be automatically associated or linked.

In some implementations, input context intervals (ICIs) can be used to improve the tracking of events in a more efficient way. An ICI is defined as a time interval having beginning and ending timestamps corresponding to a user action having a context (e.g., associated with a specific case). For example, events can be tracked by recording keystrokes. If the customer support agent is working on multiple cases at the same time, techniques of the present disclosure can be used to determine which case gets precedence. If a customer support agent is switching between systems, as noted above techniques of the present disclosure can link two systems that have their own case IDs but that are linked by the workflow. In order to be more efficient in linking cases and tracking time spent by customer support agents on each case, techniques of the present disclosure can be used to only allow one case to interrupt a second case if the duration of the interrupting event is above a threshold time. The threshold time can be a variable by specific situation and the system(s) that are involved. In computer systems that implement the techniques of the present disclosure, computer-implemented methods can be implemented for determining the primary task on which an agent is working when it appears that the agent is working on multiple simultaneous tasks. The computer-implemented methods can use configurable rules.

A browser in which the chat app executes can use an application programming interface (API) to send a data stream to a back end system for interpretation. APIs can be programmed to notice events that occur inside a browser or outside a browser. For example, a browser (e.g., Chrome) plugin can be implemented such that whenever an agent switches windows within a browser and visits a new page, the system records the event (e.g., the event data is sent to the backend system). A similar API can exist in Windows, for example, when an agent switches to a different window, sending event data to a server/backend. For example, the event data can indicate that the agent spent a specified amount of time on web site V, or the agent spent a specified amount of time in application window X with page title Y.

In some implementations, ICIs can be implemented through the use of recording timestamps instead of just recording a time duration. In this way, the timestamps can additionally be used to correct durations corresponding to the start and end times spent on a webpage by a customer support agent. As an example, the timestamps can be fitted to key strokes that occur when a customer support agent is on a particular web page.

FIG. 1A shows an example of a workforce analytics system 100 that can be used to determine discrete time spent by customer service agents on different tasks across different systems and produce reports based on discretized time, according to some implementations of the present disclosure. The workforce analytics system 100 includes a workforce analytics manager 102 that interfaces with one or more customer relationship systems 104. Each customer relationship system 104 includes one or more customer relationship applications 106, such as CRM systems. Users (such as CRM agents) can use the customer relationship system 104, for example, by accessing webpages 108 and using desktop applications 110.

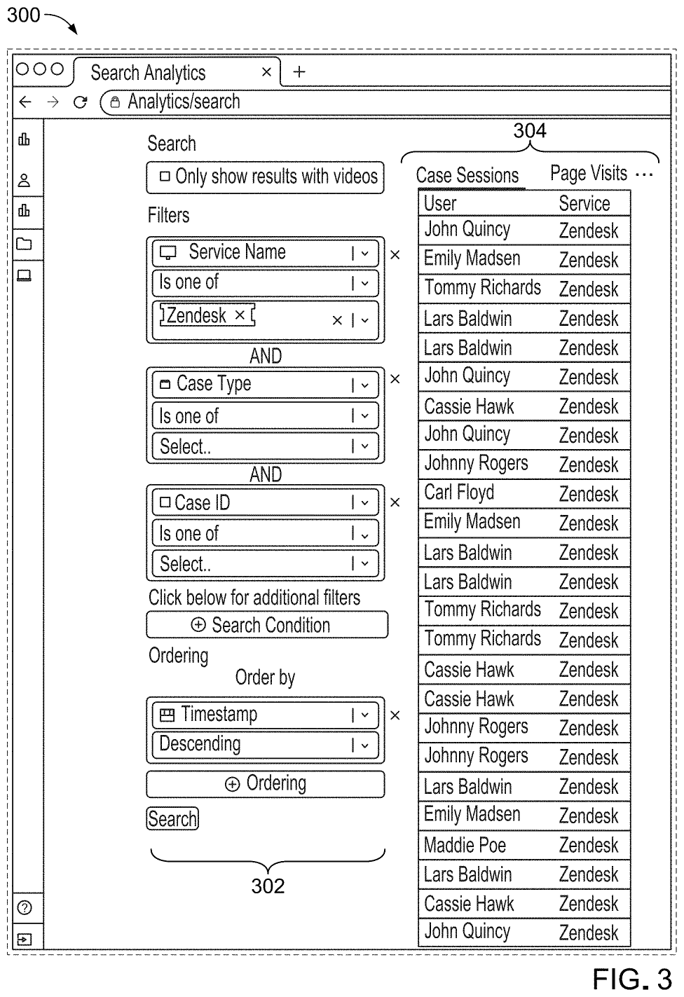

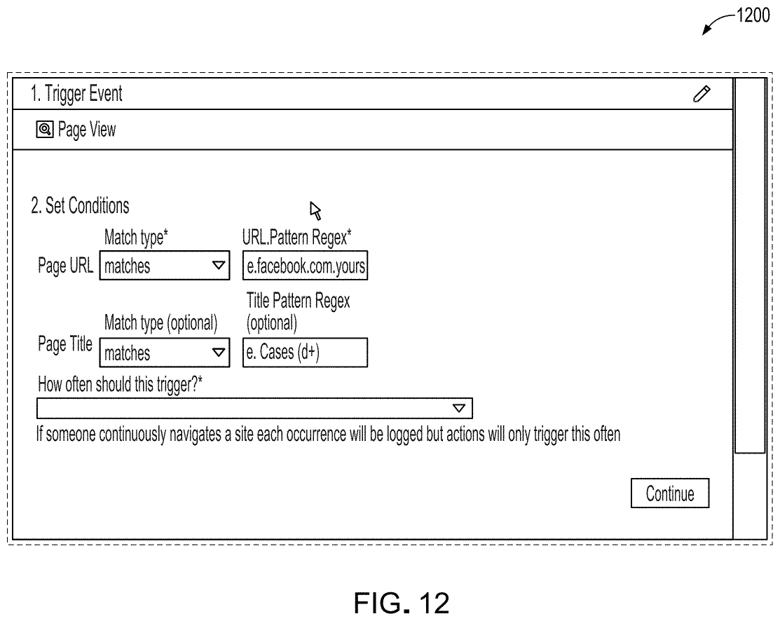

While an agent is using the customer relationship systems 104, a data stream 112 is sent to the workforce analytics manager 102 for interpretation. The data stream 112 can include discretized time data captured by browsers using APIs to send the data stream to a back end for analysis. The workforce analytics manager 102 can store the received data stream 112 as analytics data 116. The workforce analytics manager 102 can use the analytics data 116 to generate reports. The report can include, for example, reports containing information described with reference to FIGS. 3-11. Techniques by which the data stream 112 captures data include parameters and set-up operations described with reference to FIGS. 12-14C. Components of the workforce analytics system 100 are connected using a network 114 that includes, for example, combinations of the Internet, one or more wide area networks (WANs), and one or more local area networks (LANs).

Examples of reports that can be produced using discretized time data can include focus events. Focus events can be used, for example, to assign each action performed by an agent to a single “case.” An action that is assigned to a case can be disambiguated from actions performed on other cases. Discretizing the time and assigning events to specific cases can be based on cross-platform tagging for each active session. Automatic matching can occur, for example, when an agent opens a specific document within a specific period of time after opening a case. The automatic matching can use agent behavior pattern recognition that incorporates logic for timeouts, accesses to specific pages and documents, and automatic linking of identifiers from disparate systems.

The workforce analytics system 100 can perform tracking in the context of multiple workflows and multiple customers. For example, a customer service agent may have a workflow to provide a customer refund that requires the customer service agent to access a number of different systems. Based on a list or pattern of the different systems necessary for a particular type of task, workforce analytics system 100 can insure that the customer service agent follows a proper procedure while collecting metadata from each system that the customer service agent accesses and linking the metadata together.

A customer service agent may be handling multiple, simultaneously customer service cases (for example, chats) at once. Even though the time is overlapping for each of the associated customers, the workforce analytics system 100 can determine how much of their time is actually spent on each customer. The time that is tracked includes not only how much time the customer service agent is chatting with that customer, but how much time the customer service agent is spending working on that customer versus working on actions associated with another customer. The workforce analytics system 100 can use clustering algorithms and other techniques to identify that an agent is working on the same case across different systems. The clustering can occur, for example, using text copied from one box into another and based on patterns of access of different systems when handling a case.

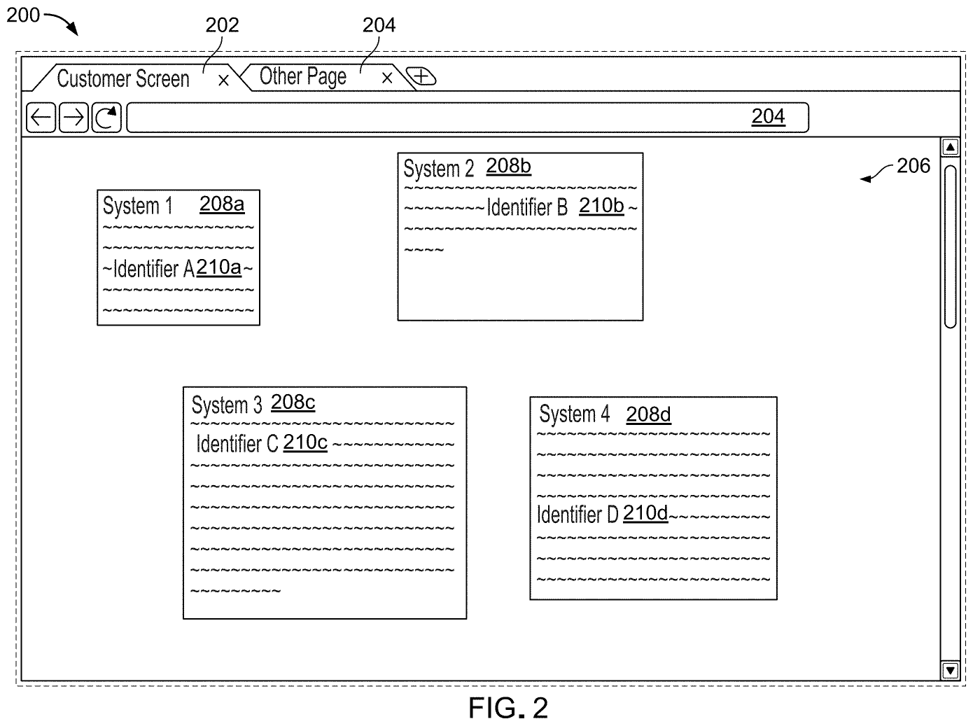

FIG. 1B shows an example of the workforce analytics manager (WAM) 102 of FIG. 1A, according to some implementations of the present disclosure. The WAM 102 includes a WAM front end 152 that provides a user interface for a user to request reports 154, for example, using analytics data 156. The analytics data 156 can include data described with reference to FIGS. 2-9. Report requests 154 can be made by a user through a web user interface (UI). Example reports can include viewing true utilization and viewing true handle time. Using the UI, the user can apply filters, including user filters and date filters (e.g., date range=last week). The analytics data 156, including user actions and event data, can serve as data input to a query engine 158 accessible through the UI for accessing relevant data for requested insights. Calculated insights 160 can be used to display report insights 162. For example, for a report providing true utilization (including user efficiency and time spent on cases), the insights can be used to create a ratio of hours active on cases and hours ready for work. Displayed reports can be displayed, for example, as table results, bar graphs, pie charts, and flow charts. Example reports are described with reference to FIGS. 2-10B.

FIG. 2 is a screenshot 200 of a customer screen 202 for handling cases in the workforce analytics system 100, according to some implementations of the present disclosure. The customer screen 202 can be an interface used by a user (for example, a customer service agent). The customer screen 202 can be one of many screens available and used in the user's browser or on the user's desktop to handle cases, including another page 204 that may present a user interface for specific products or services. An originating call, such as a chat, may originate on the customer screen 202 used by an agent. The agent may immediately or subsequently navigate to other resources, such as other pages 204, to look up the customer or perform some other action related to the case.

Working areas 206 in customer screens 202 and other pages 204 can include several pages 208a-208d (or specific screens), accessible through browsers, for example, each with corresponding identifiers 210a-210d. Other resources accessed by the customer service agent can include documents such as word documents and spreadsheets for presenting and recording information associated with a case. The identifiers 210a-210d may be completely different across the systems associated with the pages 208a-208d. However, the workforce analytics system 100 can use the analytics data 116 to associate an identifier with work done on various uncoordinated systems, which in turn can link together time spent on those different systems for the same case. The various uncoordinated systems can provide multiple software services such as web pages, documents, spreadsheets, workflows, desktop applications, and conversations on communication devices. The multiple software services include at least a software service of a first type and a software service of a second type, where the software service of the first type and the software service of the second type are uncoordinated software services lacking inter-service communication and a common identification labelling system.

In some implementations, the following steps can be used for assigning an event to a case. First, the system determines a location of a case ID or other identifier. For example, the identifier may only be seen on webpages matching specific Uniform Resource Locator (URL) patterns or using specific desktop apps. Such identifiers can be extracted from the URL, from a page/app title, or from a specific region in the HTML hierarchy of the webpage.

Each website or desktop app where an ID can be extracted is known as a service. By associating observed identifiers together with multiple services, events from multiple services can be associated together under a single case ID. The case ID can originate from whichever service the system determines to be the primary service.

To associate a first identifier with a second identifier, a sequence of events can be defined that represents the observation of identifiers in a particular order, within a bounded time-frame. The system can use this defined sequence of events to link events and their respective identifiers. Such a defined sequence can be a sequence of pages, for example, that are always, or nearly always, visited, in order and in a time pattern, when a new case is originated and handled by a customer service agent. Whenever a linked identifier is determined, that event and any subsequent events are associated with the case as identified by the identifier from the primary service.

In a working example, consider a customer service agent that engages in multiple simultaneous chats and uses a separate CRM service to look up customers and make changes to their accounts. Since the customer service agent switches between the chat windows and the CRM service, there is a need to know, specifically, how much time is spent on each customer and case. The following sequence of events can be defined.

First, the customer service agent receives a new chat box, for example, entitled “Chat 123” on a website that is considered as the primary service. The new Chat ID 123 is created, and the Case ID is marked with the Chat ID. Second, within a threshold time period (e.g., 60 seconds), the customer service agent searches the CRM system for the customer.

Third, within another 60 seconds, the customer service agent lands on the customer's page within the CRM that matches the URL pattern (for example, crm.site.com/customers/234). The CRM ID 234 is recognized, and the ID 234 is linked with Case ID 123.

Fourth, the customer service agent responds to another customer and enters a chat box, for example, with Chat ID 567. This action and subsequent actions in this chat box are not associated events with Chat 123, but instead are associated with Chat 567.

Fifth, the customer service agent goes back to the CRM system on page crm.site.com/customers/234. This surfaces CRM 234 which is linked with Chat 123, associating that event and subsequent events with case 123 until the next time case 123 is interrupted.

Note that, if the customer service agent performs other events at the same time as the sequence of events described above, such additional events do not affect the system's ability to recognize system operation. This is because certain implementations do not require that the set of events is exclusively limited to the chat and CRM events noted above.

In some implementations, the functionality of the techniques of the present disclosure can be represented in pseudocode. Assume that event stream is a variable that represents a time-ordered list of the following types of events: 1) webpage visits with URLs and page titles, 2) desktop application window events with page titles, and 3) clicks, events, and interactions within a web page on a particular webpage element or region that has its own descriptors. A case ID can be defined as any identifier associated with a service that is the primary tool used for customer communications. In such a case, pseudocode describing operation of the workforce analytics manager of FIG. 1A can include:

```
identifier_mappings = <Mapping of Case ID to list of linked identifiers>
all_possible_sequences = <List of event sequences already in process for each rules
pertaining to possible sequences of events>
current_case_id = None
for event in event_stream:
  for current_sequence_step in all_possible_sequences:
    if current_sequence_step.matches(event):
      identifiers = current_sequence_step.get_identifiers(
        event.page_title,
        event.url,
        event.html
      )
      current_sequence_step.move_to_next_step( )
      current_case_id = current_sequence_step.get_case_id( )
      # If current_case_id cannot be resolved this way look
      # for a mapping
      If not current_case_id:
        current_case_id = [
        key for (key, existing_identifiers) in identifier_mappings
        if identifiers intersects existing_identifiers
        ]
      if current_case_id:
      identifier_mappings[current_case_id].append(identifiers)
  event.case_id = current_case_id (attribute event to Case ID)
```

At a high level, the pseudocode links events (e.g., customer service agent actions) to corresponding cases and captures event information (e.g., clicks, customer service agent inputs) for the events, e.g., by stepping through a sequence of events that have occurred. Once the system has analyzed agent events and assigned those events to various cases, the system can provide a variety of useful functions. For example, FIG. 3 is a screen shot of an example of a search analytics page 300 for looking up customer service agent events, according to some implementations of the present disclosure. The search analytics page 300 includes search controls that facilitate searching for particular types of customer service agent data, for example, for actions and events by one or more specific customer service agents. The filters can be used to select customer service agent events by combinations of customer service agent name, case type, and case ID. Sorting controls can allow a user of the search analytics page 300 to sort the output of filtered information in different ways.

The search analytics page 300 displays data stream information that can be collected to identify how customer service agents are spending their time on particular cases. The information that is displayed can include case type (for example, printer fires) or specific application (for example, ZENDESK).

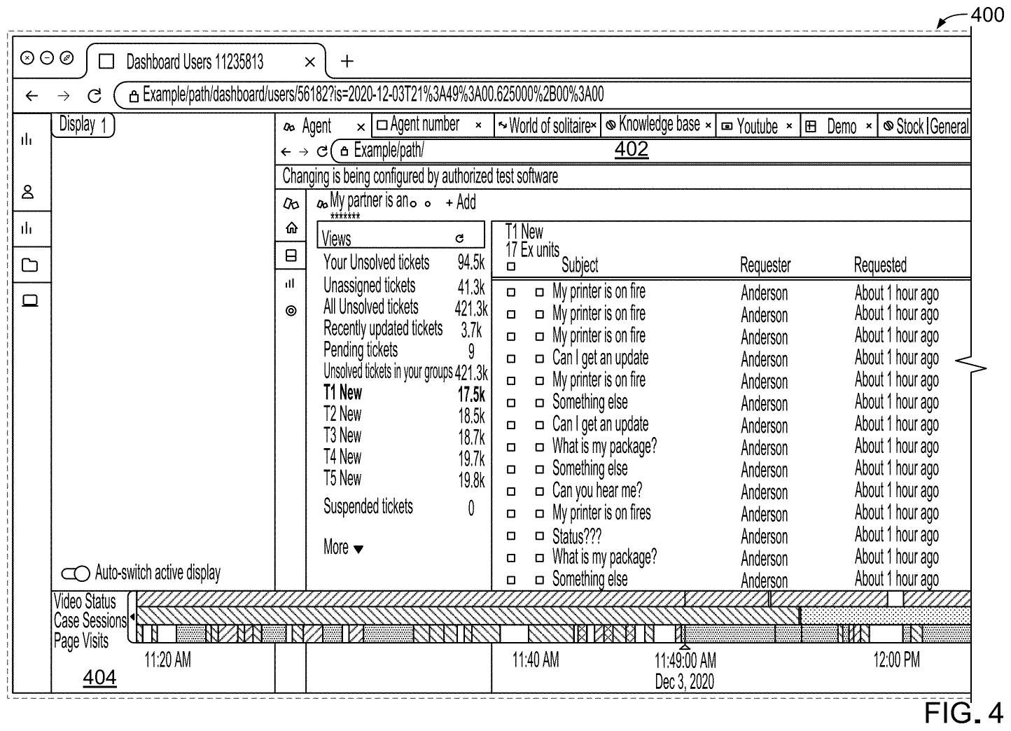

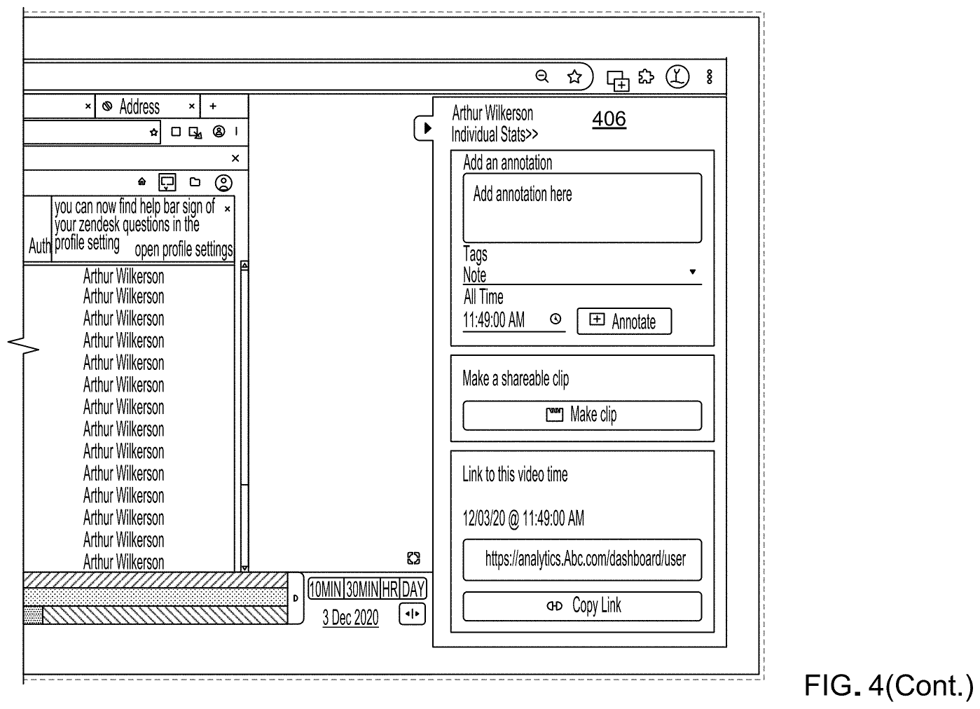

FIG. 4 is a screen shot of an example of a dashboard 400 for customer service agent time spent on cases, according to some implementations of the present disclosure. A cases information area 402 can list different cases, each case's case type (e.g., “My printer is on fire”), and other information for each case.

A video playback area 404 can allow the user of the dashboard 400 to open a video corresponding to focus events for a particular case. The case session video playback area 404 can include a video status bar, a case sessions bar, and a page visits bar. Each bar is displayed relative to time, for example, from opening a case until handling of the case is complete.

A video status bar in the dashboard 400 can allow the user to display a video of what has occurred on overlapping cases. For example, playing the video in high speed can show the overlapping case sessions on which a customer service agent has worked. The video can show, for example, that the customer service agent was working on case X, then looking at a different case, then working on case X again.

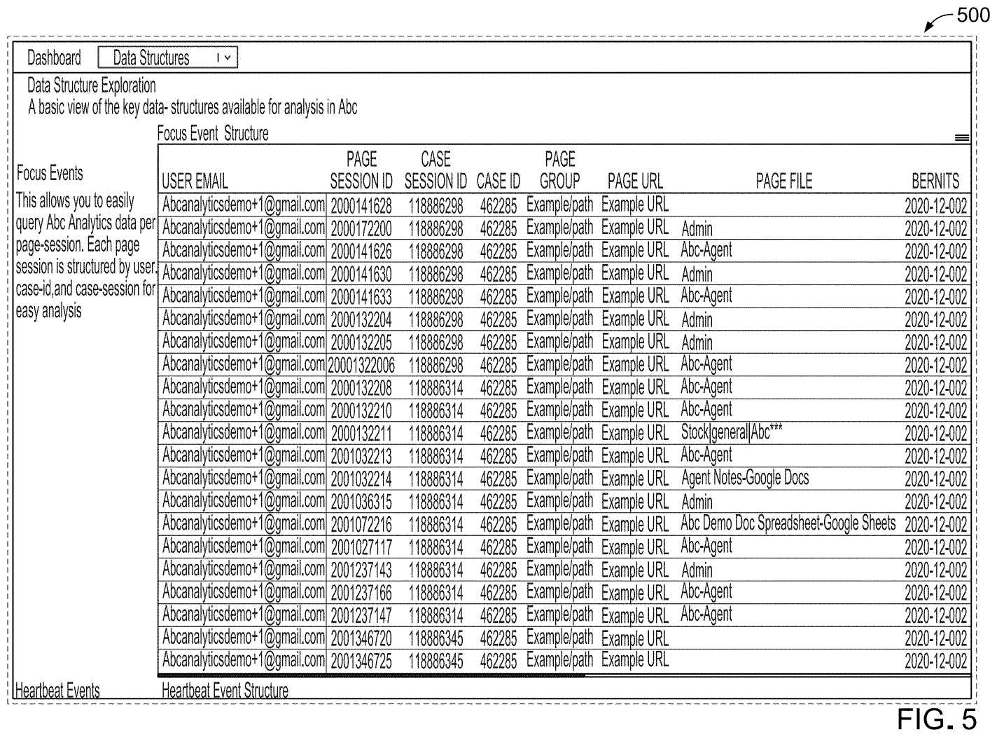

FIG. 5 is a screen shot of an example of a focus events structure 500, according to some implementations of the present disclosure. The focus events structure 500 can be used to capture and store information about page events. This can include information such as every single time the customer service agent switches pages or looks at a new resource, what case is associated, and which case session? The information can include multiple case sessions, the working customer service agent, how much time was spent, page refreshes, key presses, paste actions, and mouse scrolls.

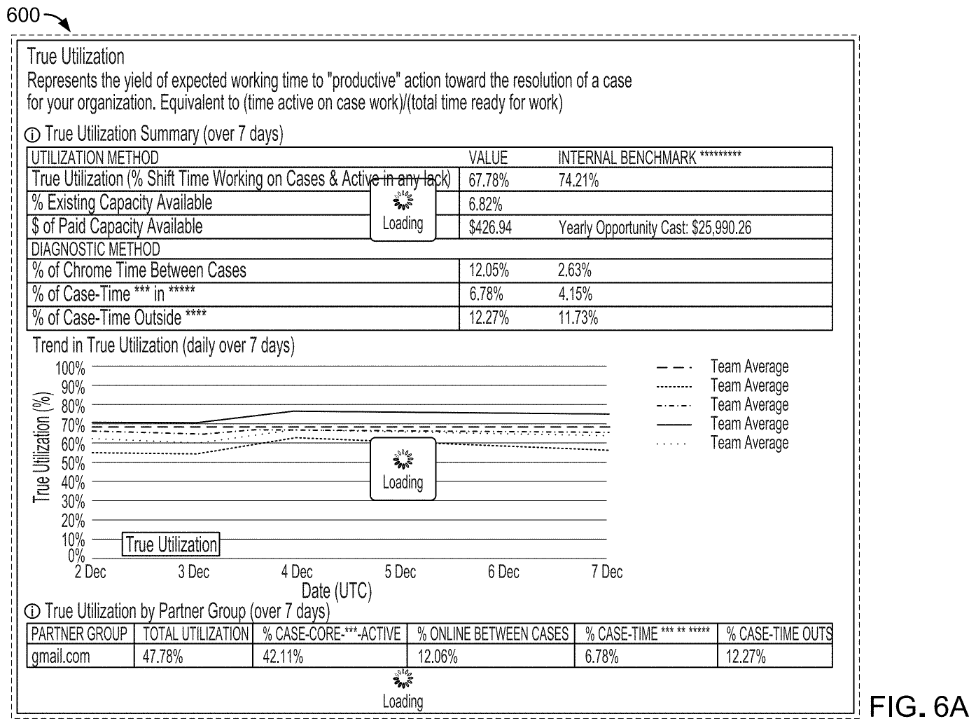

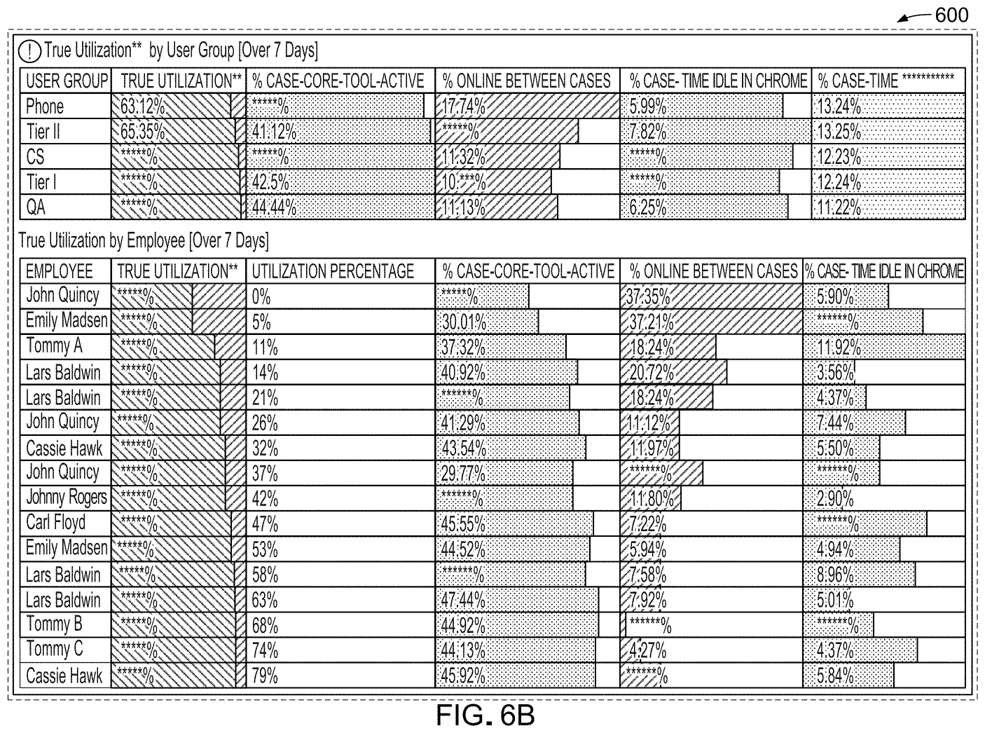

FIGS. 6A-6B are screen shots collectively showing an example of a true utilization page 600, according to some implementations of the present disclosure. The information includes heartbeats indicating, for every 60 seconds, how the CPU is performing, whether the customer service agent was active, page load events, page load times, open tabs, and slow times.

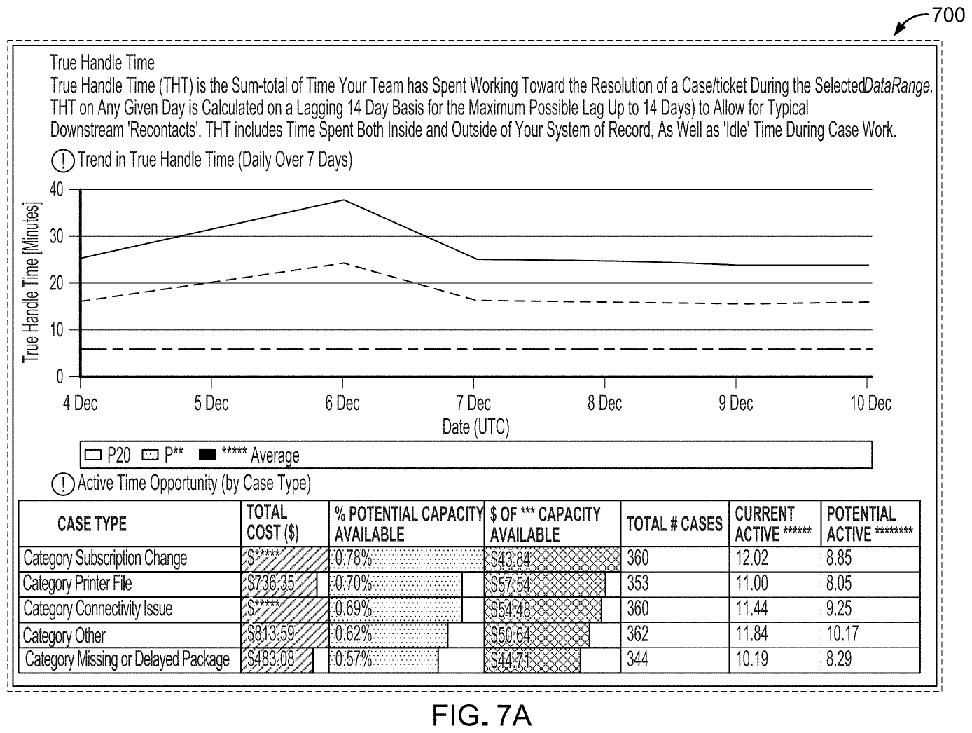

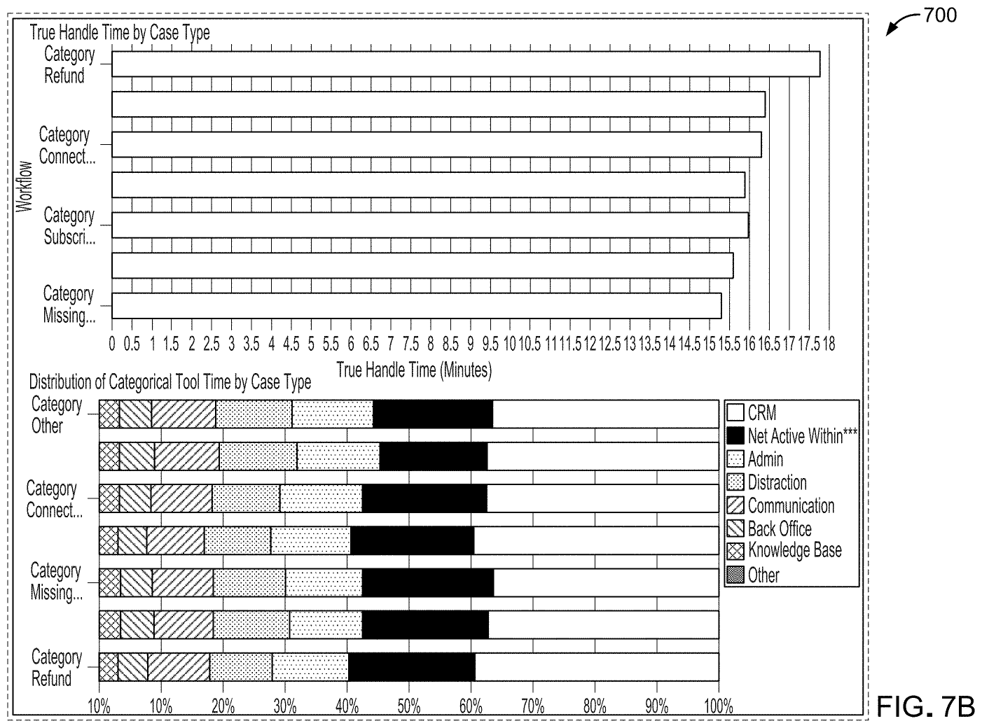

FIGS. 7A-7B are screen shots collectively showing an example of a true handle time page 700, according to some implementations of the present disclosure.

The system uses a Document Object Model (DOM) to monitor clicks, scrolls, and actual IDs of objects accessed, down to the class names. The DOM is a cross-platform and language-independent interface that treats an XML or HTML document as a tree structure, where each node is an object representing a part of the document. The DOM represents a document with a logical tree. Each branch of the tree ends in a node, and each node contains objects. DOM methods allow programmatic access to the tree. Nodes can have event handlers attached to them. Once an event is triggered, the event handlers are executed. The DOM information provides tracking of clicks, and the workflow analytics system can attach the tracked clicks and active page events to a corresponding case. This connection of clicks and active page events to a specified case can be used to understand, for each customer service agent, how active they are, and what opportunities exist for improving true handle times for a particular customer service agent.

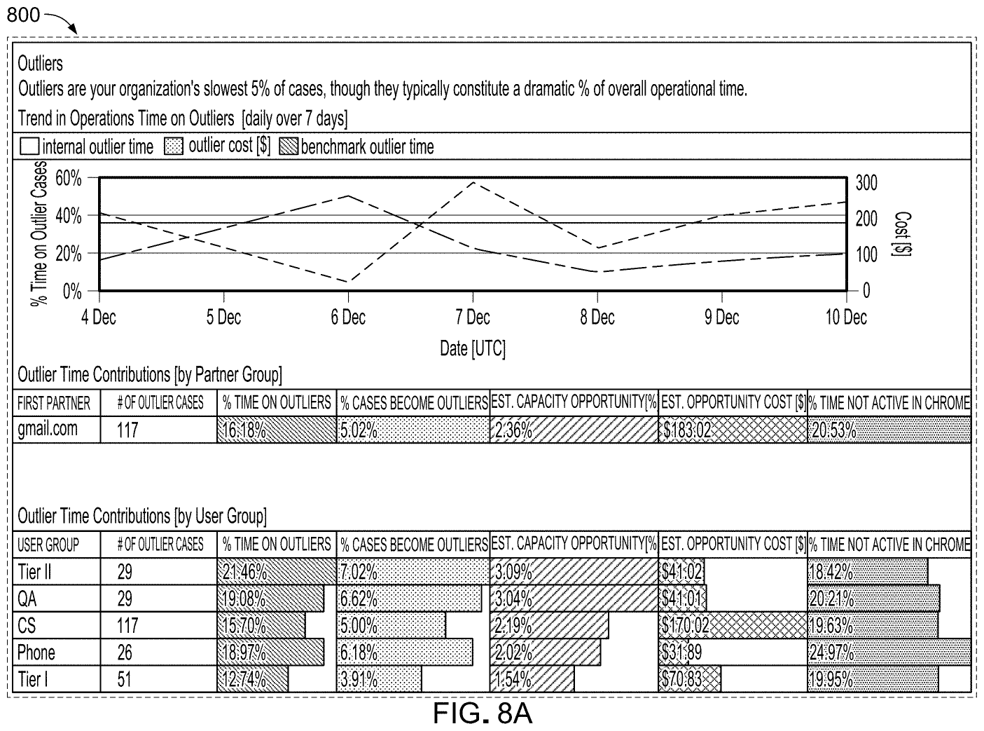

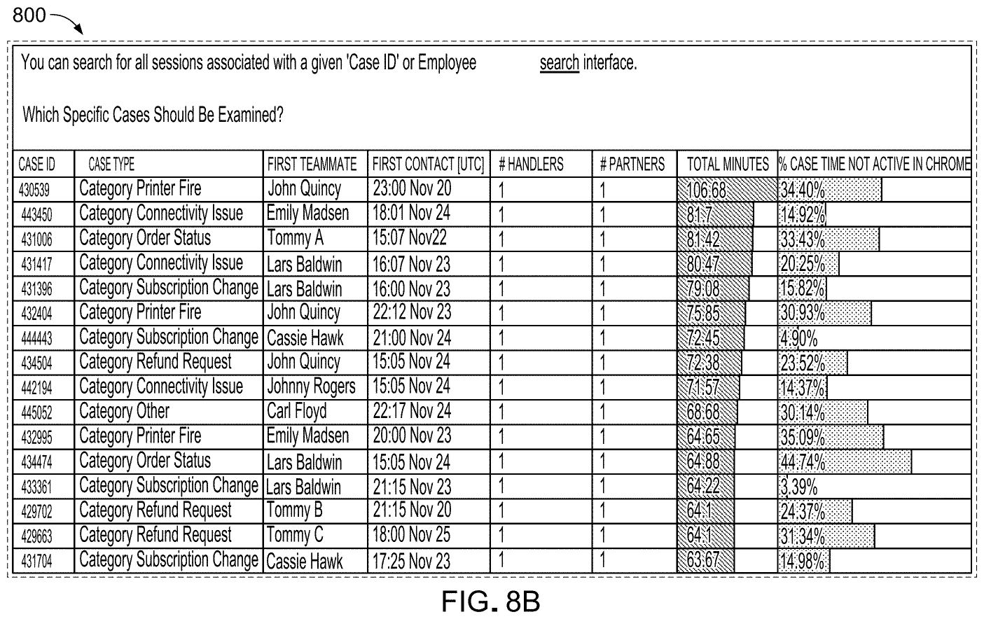

FIGS. 8A-8B are screen shots collectively showing an example of an outliers page 800, according to some implementations of the present disclosure. The outliers can identify the cases that are taking the longest.

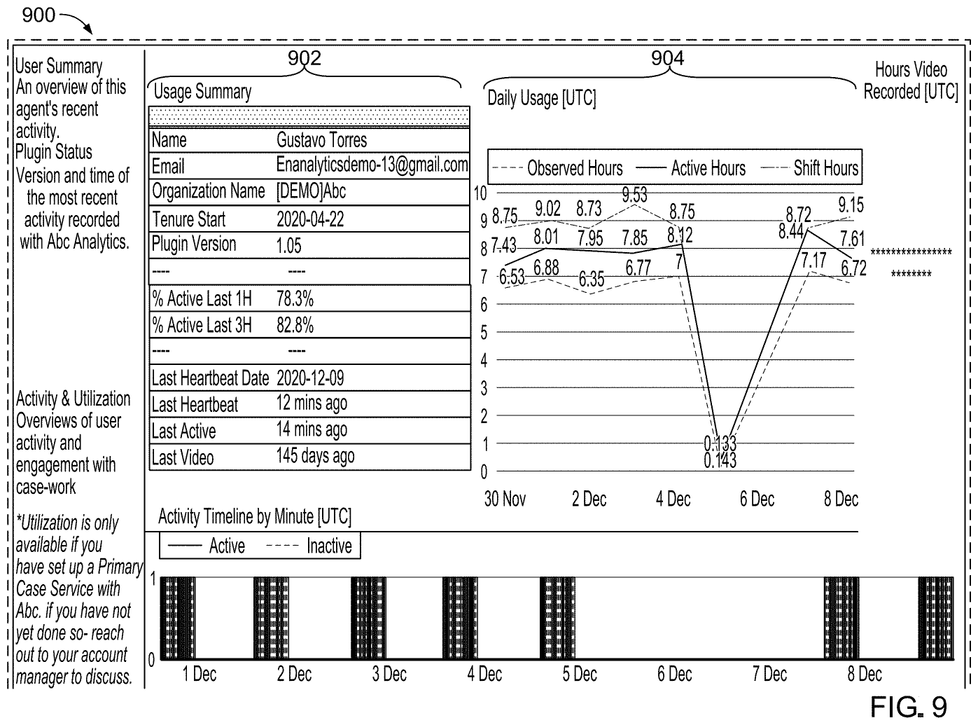

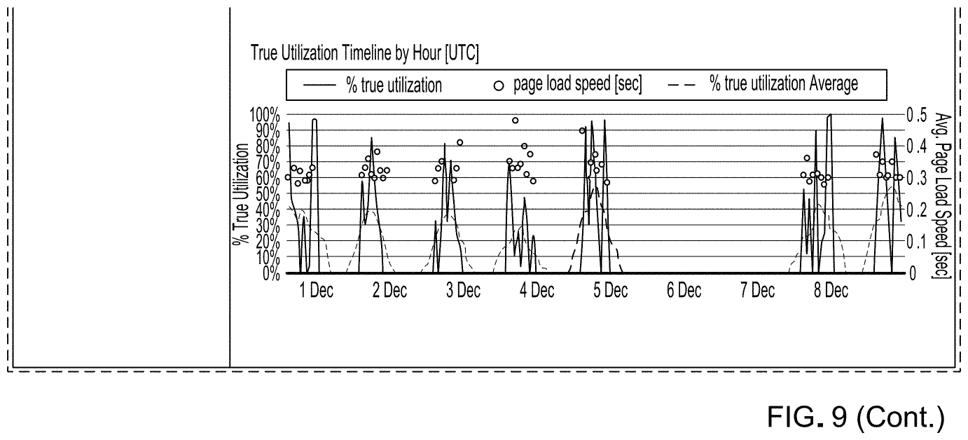

FIG. 9 is a screen shot of an example of a customer service agent summary page 900, according to some implementations of the present disclosure. The customer service agent summary page 900 includes a customer service agent summary area 902 that provides customer service agent profile information and productivity statistics for a customer service agent. A daily usage area 904 includes graphs showing customer service agent activity statistics (e.g., in hours) over time, identifying customer service agent shift hours, observed hours, and active hours.

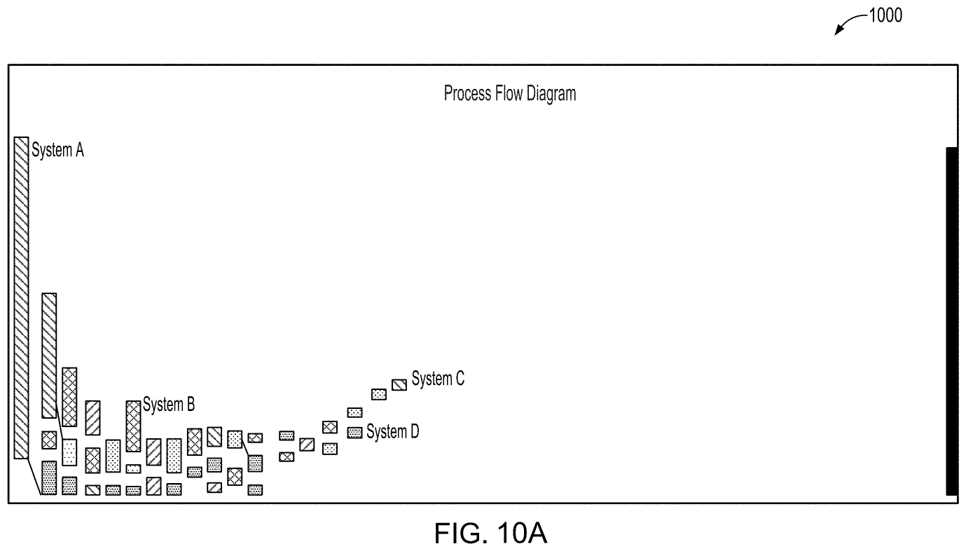

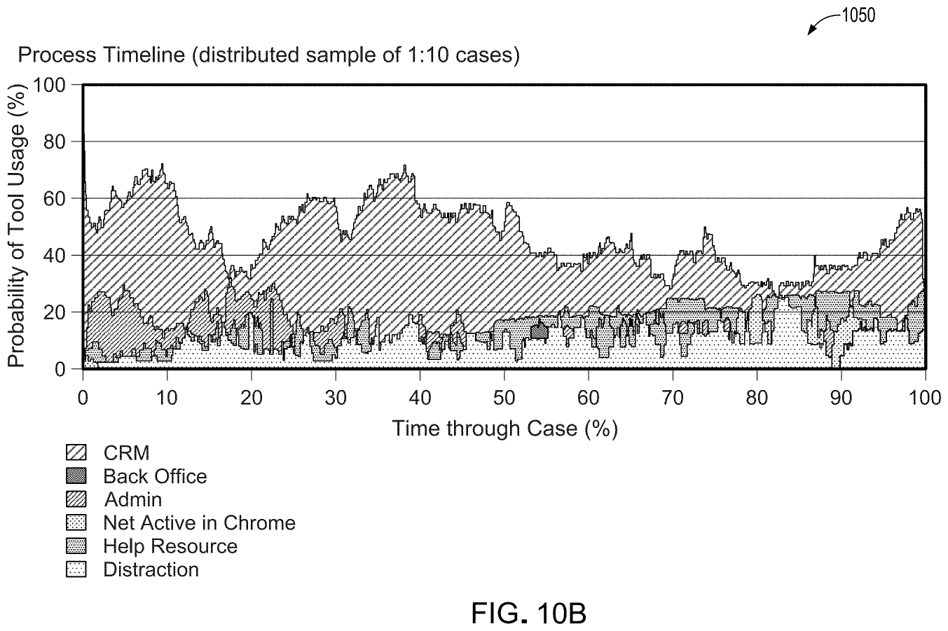

FIG. 10A is a screen shot of an example of a process flow diagram 1000, according to some implementations of the present disclosure. The diagram shows the most likely path to close a ticket based on active page events. Blocks in the diagram are arranged over time and indicate a progression of systems used by the customer service agent to work on the ticket. The blocks can be annotated with one or more of descriptive labels, shading, and color, for example, to indicate that the ticket started in CRM, moved to an administration (admin) tool, and then back to CRM.

FIG. 10B is a screen shot of an example of a process timeline 1050, according to some implementations of the present disclosure. The timeline can show the resources that were used and which ones were used a higher percentage of the time. This can identify where customer service agents are getting stuck and what is likely their next step.

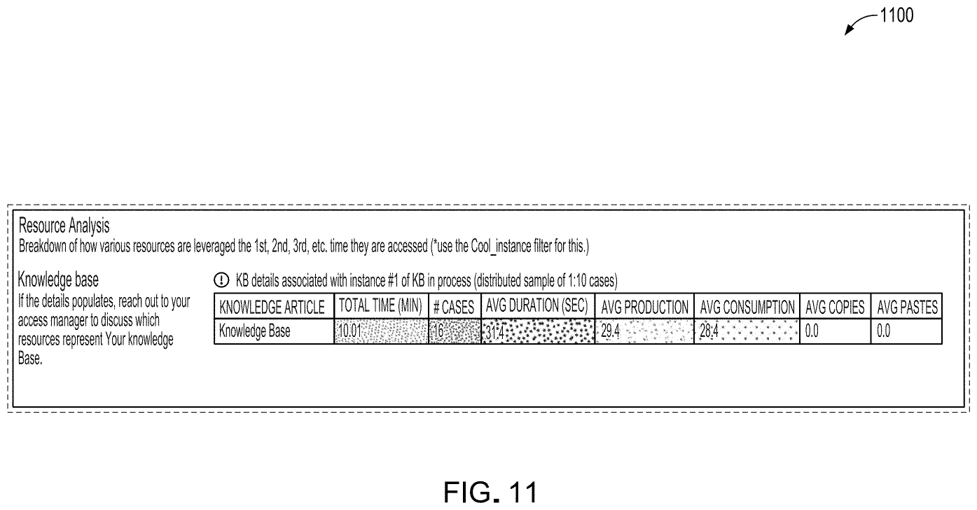

FIG. 11 is a screen shot of an example of a resource analysis page 1100, according to some implementations of the present disclosure.

FIG. 12 is a screen shot of an example of a trigger event definition page 1200, according to some implementations of the present disclosure. Trigger events effectively provide the ability to parse pages visited by a customer service agent while working on a given case. A trigger event can be used to parse the URL, for example, when a page matches XYZ, to extract the case ID out of it. This information can be used to identify how a new case is started. For example, a trigger condition can be set when the URL of a page (e.g., viewed by the customer service agent) matches a particular URL pattern, or when the title of the page matches a particular title pattern. Conditions defined on the trigger event definition page 1200 can be defined using Boolean operators for matches of URLS, titles, and HTML elements found on the page.

As an example, a trigger event can be defined for triggering a new case (or being associated with a current case) when a customer service agent navigates to a web page such as page 208a, having a specific URL. The page 208a can correspond to the first block in FIG. 10A, for example. Using defined trigger events a sequence of events can be tracked that occur in multiple software services being accessed by a customer service agent. The sequence of events can include one or more events from each case of a group of cases handled by the customer service agent. Using information extracted from one or more interactions of the customer service agent with at least one service, focus events can be determined that identify which case in the group of cases is being worked on by the customer service agent at various points in time, with each focus event having a focus event duration. Each focus event can be assigned to a particular case using the extracted information. A total period of time spent by the customer service agent on the particular case can be determined based on a sum of focus events durations for the focus events assigned to the particular case.

In an example, when a trigger (e.g., a page view) occurs, additional controls that are available from the trigger event definition page 1200 can be used to define certain responses that are to happen (or be triggered, in addition to logging the event). The responses can include, for example, creating an activity (e.g., marking this moment, or timestamp, in time), sending an email, sending a workbook, providing a Chrome notification, or redacting video. Marking the moment can cause the moment to be labeled on the timeline of the video playback area 404, for example.

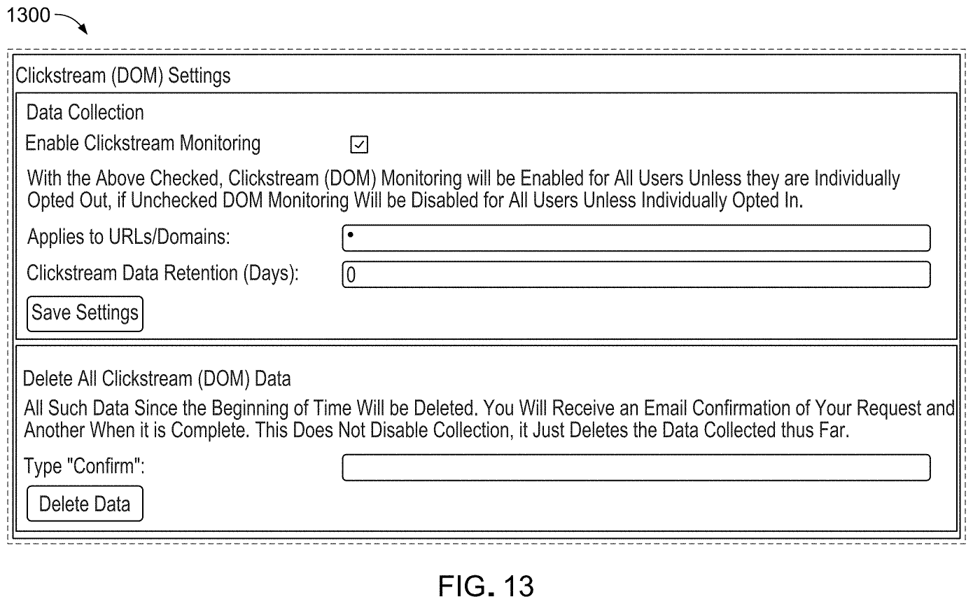

FIG. 13 is a screen shot of an example of a clickstream page 1300, according to some implementations of the present disclosure. The clickstream page 1300 can be used to identify specific data that is to be monitored and collected. Monitoring performed by the clickstream page 1300 can be filtered or limited based on opt-in and opt-out preferences set for specific customer service agents. Settings in the clickstream page 1300 can be used to define specific pages (e.g., by URL) that are to be used in monitoring and to specify a data retention time (e.g., a number of days) for monitored information. Clickstream deletion time fields can be used to control when existing clickstream data is to be deleted.

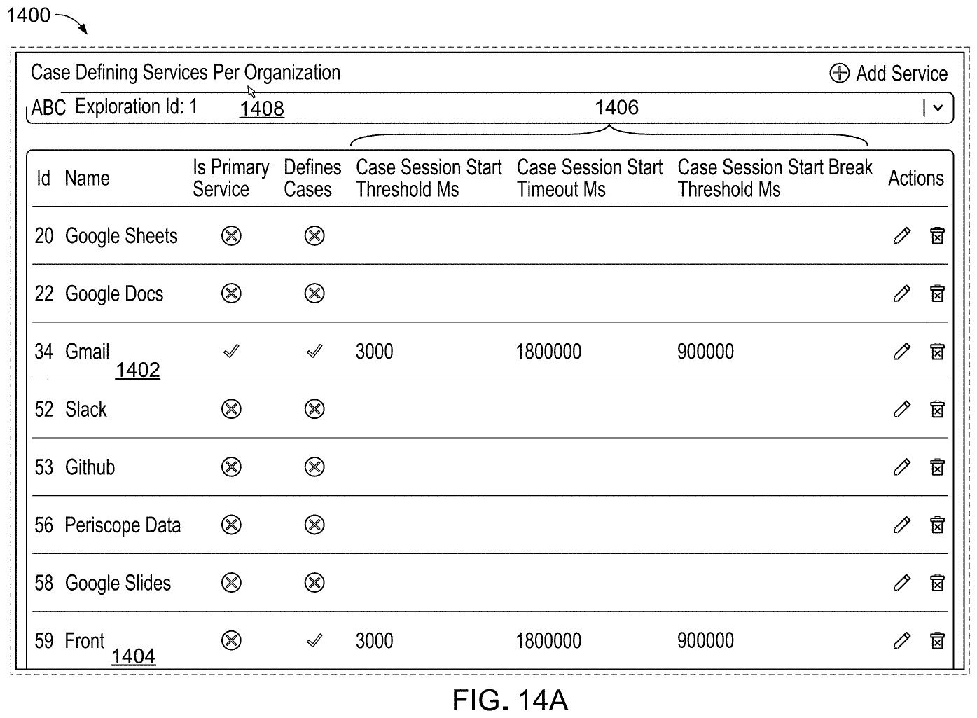

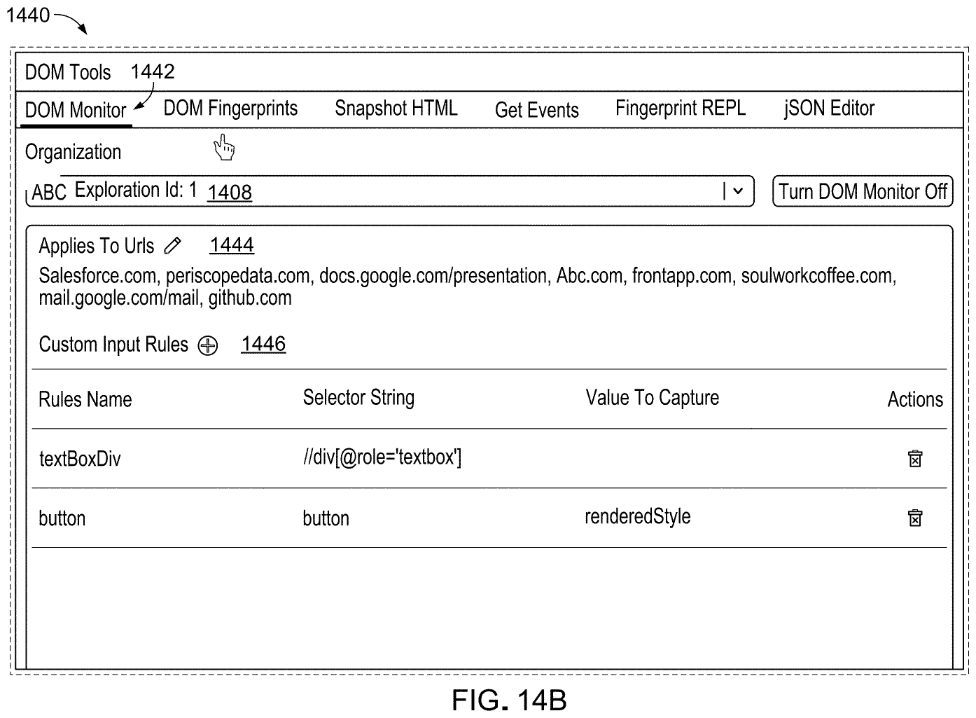

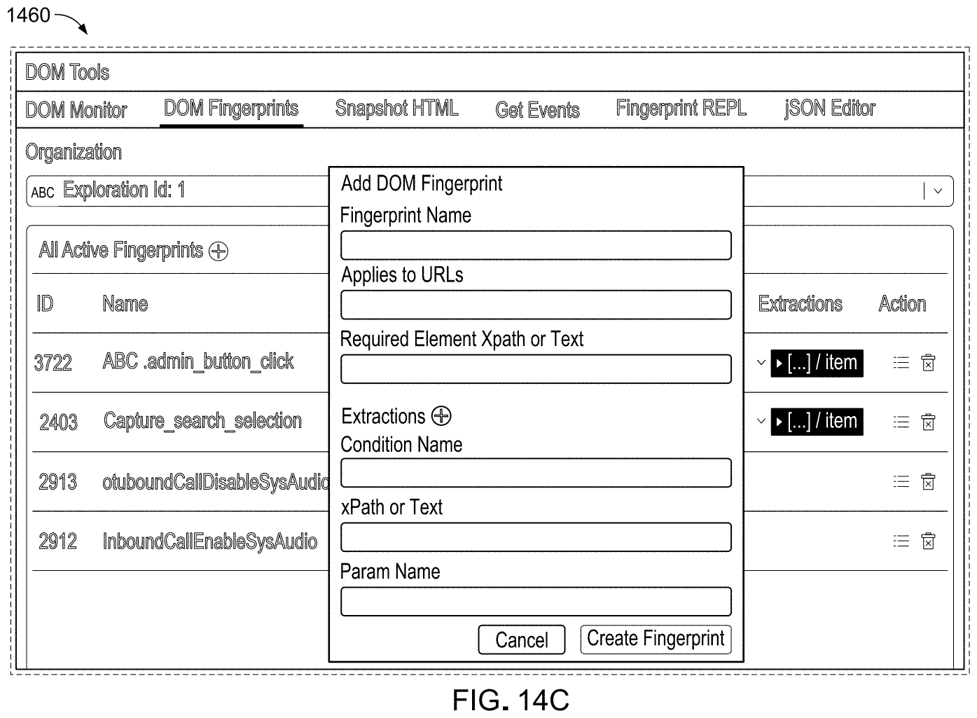

FIG. 14A is a screen shot of an example of a case defining services per organization page 1400, according to some implementations of the present disclosure. The page 1400 allows a user (such as an Administrator of agent monitoring) to identify which services apply to an organization's cases. The definitions identify the names of services and time thresholds (e.g., start, timeout, and break times) that are used to link customer service agent actions to a case. For example, for the case currently defined on the page 1400, fields of the page define a Gmail app 1402 and a Front app 1404, with time thresholds 1406, as being the apps used for cases in Organization ABC 1408. The start time indicates a minimum time that a case is in view before the case is considered being worked on by the customer support agent. Doing this avoids assigning time to a case when the customer support agent tabs through information for the case for only a moment.

FIG. 14B is a screen shot showing an example of a DOM tools page 1440, according to some implementations of the present disclosure. For a currently-selected DOM monitor option 1442, a URLs list 1444 identifies the current list of URLs that DOM settings apply to for the organization 1408. A rules section 1446 facilitates the definition of rules associated with DOM monitoring, including write a rule, for example, that defines a path of an element that starts or ends a specific case.

FIG. 14C is a screen shot showing an example of an add DOM fingerprint page 1460, according to some implementations of the present disclosure. The DOM fingerprint page provides the ability to define a fingerprint that effectively captures the path of an element effectively starting and/or ending a specific case. The fingerprint can apply, for example, to a key press, entry in a field, starting a recording, or some other action.

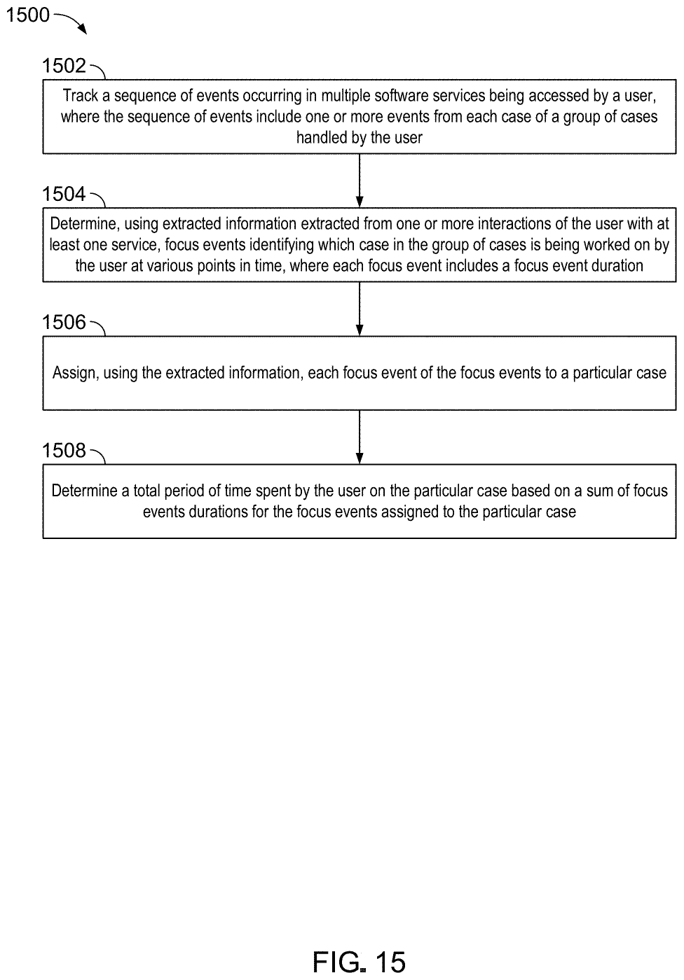

FIG. 15 is a flowchart of an example of a method 1500 for determining time spent by the customer service agent on the particular case, according to some implementations of the present disclosure. For example, the system 200 can be used to perform the method 1500. For clarity of presentation, the description that follows generally describes method 1500 in the context of the other figures in this description. However, it will be understood that method 1500 can be performed, for example, by any suitable system, environment, software, and hardware, or a combination of systems, environments, software, and hardware, as appropriate. In some implementations, various steps of method 1500 can be run in parallel, in combination, in loops, or in any order.

At 1502, a sequence of events occurring in multiple software services being accessed by a user (e.g., a customer service agent) is tracked. The multiple software services can include web pages, documents, spreadsheets, workflows, desktop applications, and conversations on communication devices. As an example, the multiple software services can include web pages used by the user within a CRM system, and the user can be a customer service representative. The sequence of events includes one or more events from each case of a group of cases handled by the user. For example, tracking the sequence of events can include the following. In some implementations, the multiple software services can include at least a software service of a first type and a software service of a second type, where the first type is CRM software and the second type is a search engine.

Focus events are recorded that identify page switches by the customer service agent, views of a new resource by the customer service agent, where each focus event identifies the customer service agent, an associated case, an associated session, a time spent on a particular page, whether the particular page was refreshed, keys that were pressed, copy-paste actions that were taken, and mouse scrolls that occurred. Heartbeats are recorded at a threshold heartbeat interval (for example, once every 60 seconds). The heartbeats can indicate CPU performance and whether the customer service agent has been active (and to what degree). Page load events are recorded including identifying a time to process a page load request, a time to finish loading the page, a number of tabs that are open, and whether a page load was slow. DOM events are recorded, including clicks by the customer service agent, scrolling by the customer service agent, an identifier of a software service, a class name and a subclass name of the software service, and content of text typed into the software service.

In some implementations, tracking the sequence of events can include setting identifier threshold rules defining a set of identifiers used in a set of systems that are to be tracked, disregarding identifiers not included in a tracked subset of the multiple software services, recording timestamps for start and end times on a particular software service, and disregarding, using the start and end times, identifiers corresponding to events that last less than a threshold event duration.

In some implementations, tracking the sequence of events can include collecting active page events, page level events, machine heartbeats, DOM events, video, audio, times when the customer service agent is speaking versus not speaking, times when the customer service agent is using video, entries written to documents, desktop application events, and entries extracted from the documents. From 1502, method 1500 proceeds to 1504.

At 1504, focus events identifying which case in the group of cases is being worked on by the customer service agent at various points in time are determined using information extracted from one or more interactions of the customer service agent with at least one service, where each focus event includes a focus event duration. From 1504, method 1500 proceeds to 1506.

At 1506, each focus event of the focus events is assigned to a particular case using the extracted information. For example, assigning each focus event of the focus events to a particular case can include linking previously unlinked identifiers from the software services by observing an expected behavioral pattern for using the multiple software services in a particular order pattern to respond to and close the particular case. In some implementations, the expected behavioral pattern can be company-dependent. In some implementations, the expected behavioral pattern can include ICIs including a timeframe defining an amount of time between a start time of the particular case and a next step performed by the customer service agent on the particular case. From 1506, method 1500 proceeds to 1508.

At 1508, a total period of time spent by the customer service agent on the particular case is determined based on a sum of focus event durations for the focus events assigned to the particular case. As an example, assigning a focus event to the particular case can include using clustering algorithms to identify and cluster a same customer corresponding to the particular case across the multiple software services. After 1508, method 1500 can stop.

FIG. 16 is a flowchart of a method 1600 for insight analysis. As described above, focus events 1602, for various workflows 1604, case sessions 1606, and cases 1608 can be monitored and tracked, e.g., by the workforce analytics manager 101. A case can correspond to a finite organizational process, such as a series of tasks that define and then solve a problem. A case may be worked on during several case sessions. Focus events can correspond to specific representative actions when working on a workflow or sequence of actions. A representative may perform different workflows during a case session.

At 1610, case duration percentiles can be calculated. Based on the case duration percentiles, cases can be grouped into various buckets. For example, case outliers can be determined (e.g., as described above for FIG. 8). A default outlier criteria can be, for example, a case between a 95%-100% level for duration. Users can configure different outlier percentages or criteria if desired (e.g., rather than base outliers on duration, a customer may want to base outliers on an amount of typing associated with the case, and change a threshold percentage for outlier determination to something other than top/bottom 5%). Another example of a bucket is cases within a case duration percentile range of, for example, 0.5 to 0.8. Such cases may be determined (e.g., from past experience or knowledge) to most benefit from workflow or process improvement. As yet another example, cases within a 0.8 to 0.95 percentile range may be identified as cases most likely to benefit from learned coaching.

At 1612, for each case, a determination can be made as to whether the case is at a case duration percentile between 0.5 and 0.8 (e.g., most likely to benefit from workflow or process improvement). At 1614, if the case duration percentile for a case is not between 0.5 and 0.8, the case is excluded from further analysis (e.g., the case can be considered an outlier).

At 1616, if the case duration percentile for the case is between 0.5 and 0.8, the case can be considered to not be an outlier and a count of the number of knowledge articles accessed during the case can be calculated, using the focus events 1602, and an amount of time spent on articles during the case can be calculated.

At 1618, averages of knowledge article access counts and a duration of time spent on articles are determined using information for a group of specified cases (e.g., the specified cases can be all cases occurring during a specified time period for a specific entity).

At 1620, a determination is made for each case as to whether the article count for the case or the duration of time spent on articles for the case is greater than a respective corresponding average for the group of specified cases.

At 1622, if neither the article count for the case nor the duration of time spent on articles for the case is greater than the respective corresponding average for the group of specified cases, the case is excluded from output of the insight analysis.

At 1624, if either the article count for the case or the duration of time spent on articles for the case is greater than the respective corresponding average for the group of specified cases, a case identifier for the case can be surfaced (e.g., included in a report or user interface) as being associated with an excessive knowledge cost. A report can include a recommendation to review associated knowledge resources which may have caused the excessive knowledge cost. Alternative or replacement knowledge resources for case types for which an excessive knowledge cost is identified may need to be considered, for example.

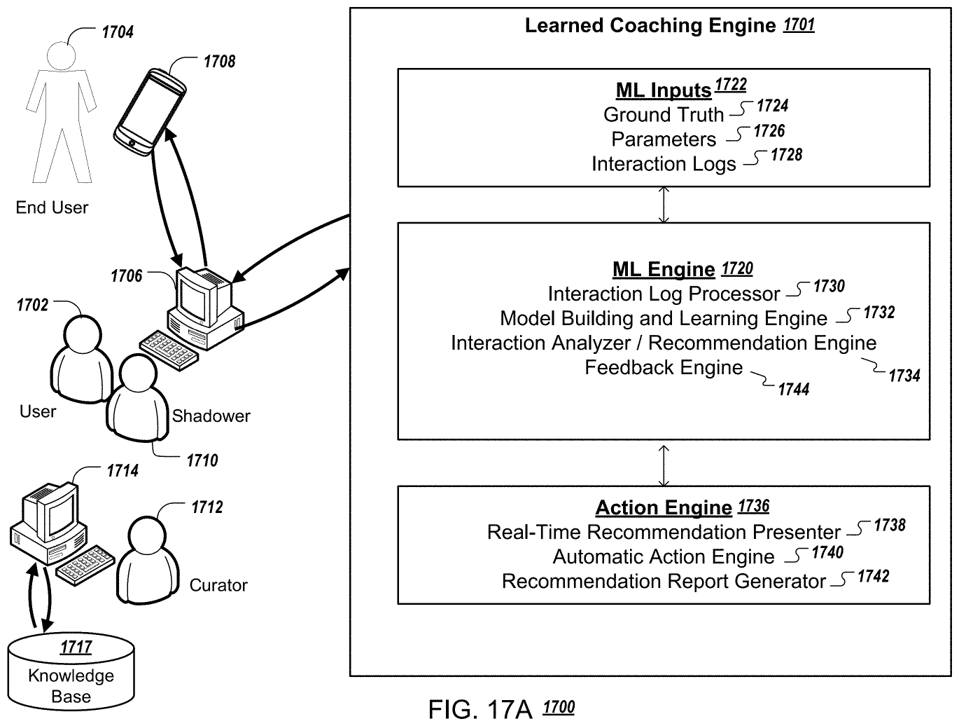

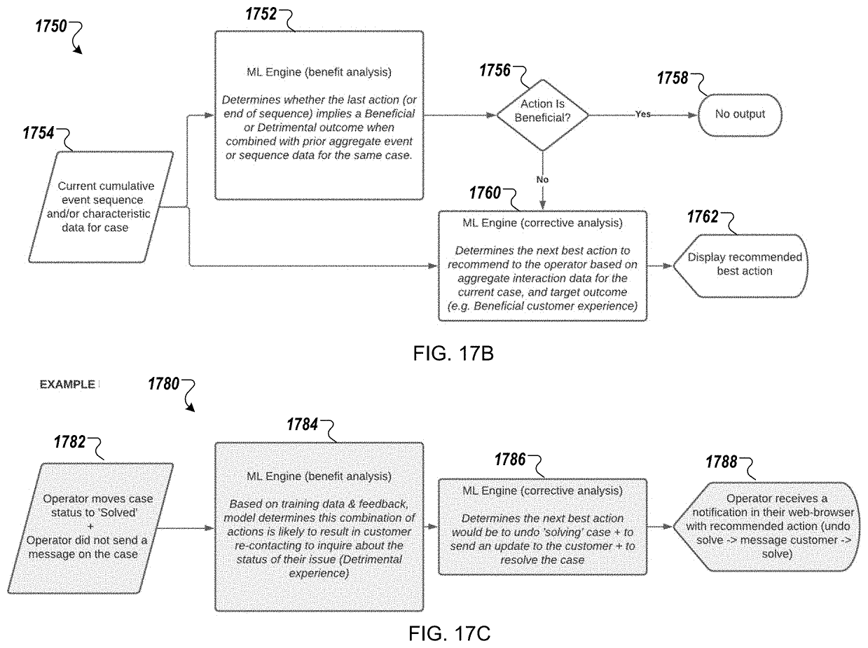

FIG. 17A is a block diagram illustrating an environment 1700 that includes a learned coaching engine 1701. The learned coaching engine 1701 can be a part of the workforce analytics manager 101, for example. As described above, support representatives, such as a support representative 1702, can provide support for users, such as a user 1704. The support representative 1702 can perform support interactions using a computing device 1706 and/or other devices(s). The user 1704 can contact a support system using a device 1708, which may be a smartphone as illustrated (e.g., using a voice call and/or browser or application connection) or some other type of device.

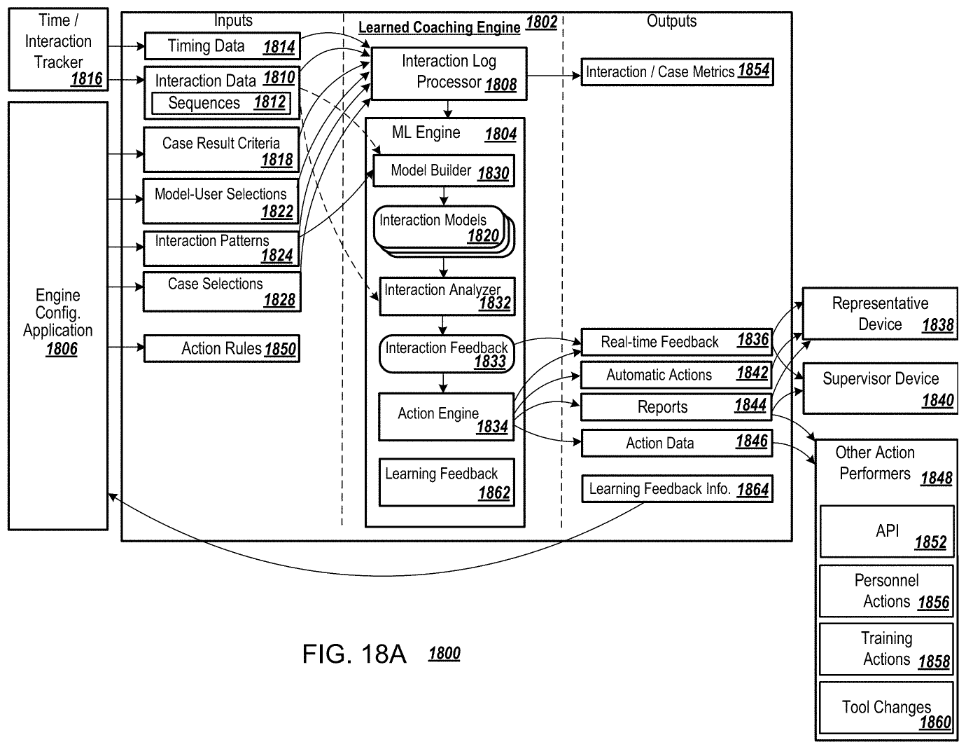

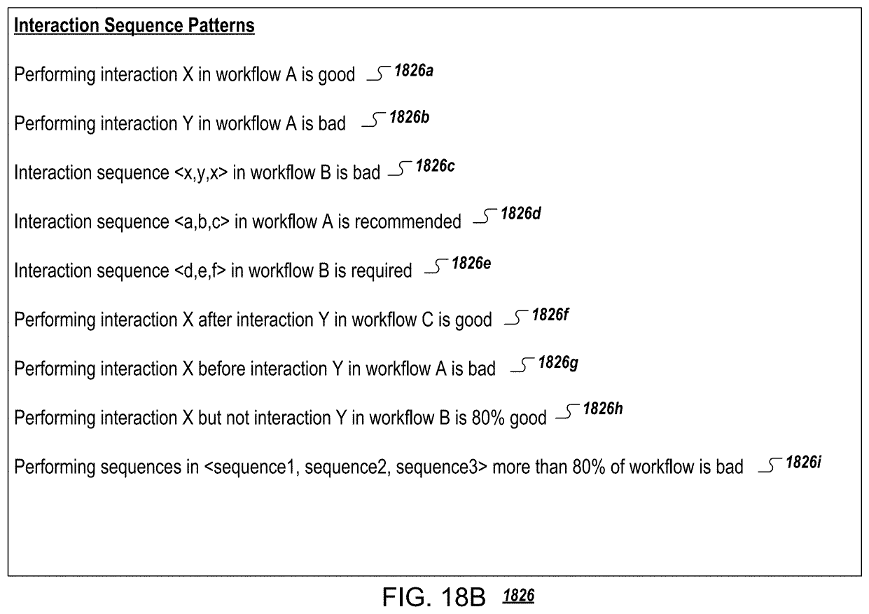

Various approaches can be used to train and monitor the support representative 1702. For example, a shadower 1710 (e.g., a coach) can manually monitor and provide manual (e.g., verbal, written) feedback to the support representative 1702. As another example, a curator 1712 can curate (e.g., using a computing device 1714) a knowledge base 1716 (or a learning management system). As described above, learning management system, knowledge-base, and manual coaching approaches have various disadvantages. As an improved training and process improvement approach, the learned coaching engine 1701 can be used for the support representative 1702 (and other support representatives). FIG. 17 illustrates an overview of the learned coaching engine 1701. FIG. 18 provides a more detailed description of the learned coaching engine and various machine learning approaches.

The learned coaching engine 1701 includes a ML (Machine Learning) engine 1720 that can be trained using a variety of inputs 1722. For example, the ML engine 1720 can be trained using ground truth data 1724 such as interaction data associated with cases that have been identified as having either a good case result or a bad case result and interaction data associated with model users who have been identified as model user performers for certain case types. Ground truth data 1724 can also include specified interaction patterns that are specified as correlating to either a good case result or a bad case result for a particular case type. The ML engine 1720 can also receive different types of parameters 1726 that can be used, for example, for processing of interaction logs 1728 by an interaction log processor 1730. The parameters 1726 can include, for example, case result criteria that specifies conditions (e.g., customer satisfaction values, case duration) for what constitutes a good or base case result. Although shown as separate from the ground truth data 1724, some interaction logs 1728 (and corresponding case outcome information) can be used as ground truth data 1724 when training the ML engine 1720.

For example, the interaction log processor 1730 can locate interaction data for cases that have been identified as being associated with a good or bad case result, including interaction data associated with the model users and interaction data having at least one of the specified interaction patterns. A model builder and learning engine 1732 can build machine learning models that each include learned model interaction behavior for a given case type. As described in more detail below, machine learning models can also be personalized for a given user.

In further detail regarding the ML engine 1720, the ML engine may use supervised and/or unsupervised machine learning, depending on a given entity's level of integration with the system 1700. For example, unsupervised learning may be used for a first entity who chooses to not participate in integrating outcome metrics into the ML engine 1720, where outcome metrics can include, for example, CSAT (Customer Satisfaction) data from an entity system, operator performance metrics, etc. As another example, the first entity may choose to not review and provide feedback on past interactions. The ML engine 1720 may be an unsupervised ML engine for the first entity, and starting dimensions for an unsupervised model can include, for instance, 15-20 dimensions, such as features of a focus event (e.g., URL (Uniform Resource Locator), URL classification), event duration, and user interface actions such as mouse clicks, keypress counts, backspace counts, and scrolling counts. Dimension reduction can be performed to reduce the starting dimensions to a lesser set of dimensions that are determined to be predictive.

As another example, a second entity may be more involved with regards to integrating feedback into the ML engine 1720, and for the second entity, a supervised machine learning model may alternatively (or additionally) be used, as or in the ML engine 1730. Feedback can include external integrations with outcome metrics such as CSAT or performance metrics, or direct entity feedback of results fed back into the ML engine 1720. An example supervised model is a random forest ML model. An example loss function that can be used with the random forest model is MSE (Mean Squared Error) regression. Example inputs to the supervised model can include the following: 1) resource URL and classification for most recent action; 2) type of action (e.g., mouse click, keypress, mouse scroll, other focus event action); 3) value or magnitude of the action (e.g., three mouse clicks, twelve keypresses); and 4) aggregate prior value / magnitude of action type on the case (e.g., twelve prior clicks, thirty seven prior keypresses). Training input can include feedback scores (e.g., CSAT values for interactions, operator's average CSAT score). Example hyperparameters for the supervised model can include 1) sample with replacement; 2) depth (e.g., no max depth, or start at moderate/high depth(e.g., depth of fifty)); 3) number of samples per leaf (e.g., can start low, but can use a value greater than one, such as two); 4) number of samples to split (e.g., can start low, but can use a value greater than one, such as two); 5) number of features (e.g., can start at a low or moderate level, such as five); and 6) number of estimators (e.g., can start at a high level, such as 500).

After the ML engine 1720 has been trained, an interaction analyzer/recommendation engine 1734 can receive interaction data for the support representative 1702 for interactions occurring in multiple software services used by the user during handling of a case. The interaction analyzer/recommendation engine 1734 can identify a machine learning model built by the model building and learning engine 1732 that includes learned model interaction behavior for a case type of the case. The interaction analyzer/recommendation engine 1734 can compare interaction data for the user to the learned model interaction behavior and generate action data that includes an interaction behavior improvement recommendation that is determined based on the comparing of the interaction data for the user to the learned model interaction behavior for the case type.

An action engine 1736 can take action based on the action data. For example, when the analyzed interaction data is real-time interaction data, a real-time recommendation presenter 1738 can present the behavior improvement recommendation to the support representative 1702 to direct handling of the case (e.g., to increase a likelihood of a good case outcome). As another example, an automatic action engine 1740 can automatically perform one or more interactions on behalf of the support representative 1702. As yet another example, when the analyzed interaction data is historical interaction data, a recommendation report generator 1742 can generate a report that can include the behavior improvement recommendation (and possibly other improvement recommendations generated for other cases or other interactions). A feedback engine 1744 can be used to further update the machine learning model, based on new interaction data and new case results, performing of behavior recommendations and resultant effect on case results, deviations from or an ignoring of a recommendation, etc.

As a particular example of use of the learned coaching engine 1701, the support representative 1702 may begin work on a case within a case management application. The learned coaching engine 1701 (or another component, such as an interaction tracker) can recognize the start of work by the support representative 1702 on a new task. The support representative 1702 may use a browser on the computing device 1706 to navigate away from the case management application towards an external website. The interaction analyzer/recommendation engine 1734 can analyze the pattern of navigation and compare the pattern of navigation to previously-sampled patterns of navigation as well as to customer satisfaction outcome metrics associated with the prior pattern samples. The interaction analyzer/recommendation engine 1734 can determine that the current behavior of the support representative 1702 is likely to result in a poor customer experience.

Various types of predicted metrics can indicate that a poor customer experience may occur. Predicted metrics can include predicted customer satisfaction (e.g., predicted NPS (Net Promoter Survey) results, predicted CSAT) or predicted customer wait time. As another example, detected operator uncertainty or confusion may predict a likely poor customer experience. For example, the operator may be performing a high degree of typing, deleting, and retyping cycles, or may be visiting a higher number of different knowledge resources than expected, or may be pinging multiple other communication channels for insight when composing a response.

As another example, an operator may be performing workflow non-adherence. That is, the operator may be performing actions that don't adhere to a prescribed process for the type of case they are handling. For example, the operator might not have provided a refund or credit when the customer request is for a reimbursement, or the operator may have cancelled a reservation when the customer request was for a reservation adjustment.

Another example of an indication of likely poor customer experience may be that a number of operators working on the same request has exceeded a threshold number of operators (e.g., the great the number of operators may indicate a higher likelihood of an operator losing sight of important case details or context and performing an incorrect action). A number of concurrent tasks may also be a measure of customer experience prediction. For example, an operator handing more than a threshold number of concurrent chat sessions may indicate a higher likelihood of making mistakes or paying less attention to customer details.

In some cases, a hardware/workstation setup may at least in part indicate a likely customer experience for certain cases or situations. For example, an operator with only one display screen may not be able to successfully handle multiple concurrent tasks, or as complex of tasks as an operator who has multiple configured screens for concurrently reviewing multiple information sources. Accordingly, hardware setup combined with number of concurrent cases may be a customer experience indicator. Network infrastructure and capacity can also indicate customer experience. For example, an operator who has poor network connectivity (at least at the current moment) may be less likely to successfully handle certain types of interactions, such as phone calls or screen sharing, than operators who are have adequate network performance.

Detection of prohibited or negative language or vocabulary may indicate an undesirable customer experience. Other types of indicators may indicate potential undesirable customer experiences, such as detecting accesses of known non-productive resources while handling a case, detection of certain eye movement patterns of facial expressions indicating lack of focus, etc.

The interaction analyzer/recommendation engine 1734 can determine a next best action for the support representative 1702 to take to increase the probability of a good customer experience. The real-time recommendation presenter 1738 can send a notification to the support representative 1702 with recommended instructions for the next action(s) the support representative 1702 should perform. As another example, the automatic action engine 1740 can automatically perform the next action(s) and alert the support representative 1702 of what actions were automatically performed. The support representative 1702 can perform the remainder of the actions for handling the task for the case. The learned coaching engine 1701 can track the remainder of the actions of the support representative 1702 for the task as well as the eventual customer experience outcome for the task and case. The feedback engine 1744 can update a machine learning model for the support representative 1702 and task type to increase the efficiency of future recommendations or automated processing pertaining to the support representative 1702 or the task type.

FIG. 17B is a flowchart of a method 1750 for determining a learned coaching action to perform using a machine learning engine.

At 1752, a ML engine receives input 1754 that includes a current cumulative event sequence for an operator and/or characteristic data for a case of the operator.

At 1756, the ML engine determines whether a last action (or end of a sequence of actions) of the operator implies a beneficial or detrimental outcome when combined with prior aggregate event or sequence data for the same case.

At 1758, in response to determining that the last action implies a beneficial outcome, the ML engine can determine to not produce any learned coaching outputs. For instance, the ML engine can determine that no coaching is needed, based on the last action implying a beneficial outcome.

At 1760, in response to determining that the last action does not imply a beneficial outcome, the ML engine can perform corrective analysis, to determine a next best action to recommend to the operator based on aggregate interaction data for the current case and a target outcome (e.g., where the target outcome can be a positive customer experience).

At 1762, information describing the next best action is displayed for the operator, to direct the operator to perform the next best action.

FIG. 17C illustrates an example 1780 of performing learned coaching actions determined by a machine learning engine. At 1782, an operator performs an example action of moving (e.g., changing) a case status to a value of “solved” even though the operator had not yet sent a message to the customer being serviced regarding resolution of the case. At 1784, a ML engine, based on training data and feedback, determines that the combination of changing a case status to solved without having notifying the customer being serviced is likely to result in a negative outcome of the customer re-contacting customer service about the status of the issue for which the case occurred. At 1786, the ML engine performs corrective analysis to determine next best action(s) to perform to avoid the negative outcome. For example, the ML engine can determine that a next best set of actions includes changing the case status back to an unsolved state, sending an update message to the customer informing the customer that the case is solved (e.g., with details regarding the resolution), and then setting the case status to solved after the customer has been notified. At 1788, information describing the next best actions to perform is automatically displayed to the operator, so that the operator can perform the recommended actions, so that the negative outcome is avoided.

FIG. 18A is a diagram of the components of an exemplary system 1800 for automatic generative learned process coaching in a digital environment. The system 1800 includes a learned coaching engine 1802. A machine learning (ML) engine 1804 included in the learned coaching engine 1802 can be trained, using various types of input data provided, for example, by an administrator using an engine configuration application 1806 and/or indirectly by an interaction log processor 1808 that can process interaction logs that include interaction data 1810 (including sequences 1812) and timing data 1814 generated by a time/interaction tracker 1816.

For example, an administrator can specify, using the engine configuration application 1806, different types of case result criteria 1818. For example, the case result criteria 1818 can include threshold values that indicate good or bad case results, such as customer satisfaction scores being less than 70% indicating an unacceptable case result and customer satisfaction scores over 90% indicating a particularly good case result. As another example, case session duration time thresholds can be specified, which can be specified per case type. For instance, for a particular case type such as hardware issues, case session duration times of less than one minute or more than ten minutes may indicate a potential issue with handling of the case (e.g., too little or too much time spent). Although case result criteria 1818 is described, case session and/or workflow result criteria can be defined, for specific types of cases sessions or workflows which may be part of handling a case.

The case result criteria 1818 can be provided to the interaction log processor 1808. The interaction log processor 1808 can use the case result criteria 1818 to locate interaction log entries that match the case result criteria 1818. For instance, the interaction log processor 1808 can locate interaction logs entries that correspond to good case results and bad case results, according to the case result criteria 1818. Located interaction log entries that correspond to either good or bad case results can be provided to the ML engine 1804. The ML engine 1804 can use the interaction log entries that correspond to either good or bad (or a degree of either good or bad) case results when building interaction model(s) (e.g., an interaction model 1820), as described in more detail below. In some implementations, the interaction log processor 1808 can perform other processing using the case result criteria 1818 as input. For example, the interaction log processor can determine or identify, from the located interaction log entries that correspond to either good or bad case results, best (or worst) representatives, which can be aggregated by team, site, or other grouping(s), for example.

As another example of training data, an administrator can specify, using the engine configuration application 1806, model-user selections 1822. The model-user selections 1822 can indicate particular representatives that have been selected by an organization as model representatives that may be used for determining patterns of good behavior. The model-user selections 1822 may have been determined based on past employee reviews, or performance in historical time periods, for example. The interaction log processor 1808 can locate interaction logs that are associated with the model-user selections 1822 (e.g., from a specified time period, such as the previous or the current month, the current year, etc.). The interaction log processor 1808 can provide the located interaction logs that are associated with the model-user selections 1822 to the ML engine 1804, for use in interaction model building, as described in more detail below.

In some implementations, an administrator can provide specified interaction patterns 1824 as good or bad interaction patterns. For example, for a particular workflow or case type, the administrator can specify various pattern rules or sequences that indicate good or bad behavior. Certain prescribed behavior may be recommended or considered model good behavior, for example.

As shown in example interaction patterns 1826 in FIG. 18B, the administrator can define interaction patterns 1826a-1826i, respectively, of 1) Performing interaction X in workflow A is good; 2) Performing interaction Y in workflow A is bad; 3) Interaction sequence <x,y,z> in workflow B is bad; 4) Interaction sequence <a,b,c> in workflow A is recommended; 5) Interaction sequence <d,e,f> in workflow B is required; 6) Performing interaction X after interaction Y in workflow C is good; 7) Performing interaction X before interaction Y in workflow A is bad; 8) Performing interaction X but not interaction Y in workflow B is 80% good; or 9) Performing sequences in <sequence1, sequence2, sequence3>more than 80% of workflow is bad. Other types of patterns, or combinations of patterns can be specified.

As shown in FIG. 18B, interaction patterns can be specified as “good” or “bad”, or some other binary designation. As another example and as shown in interaction patterns 1826e and 1826d, respectively, other labels can be assigned to interaction patterns, such as “required,” or “recommended.” Interaction pattern 1826h illustrates an assigned weighting (e.g., 80% good). Other designations can be used for labeling or classifying interaction patterns. For example, interaction pattern 1826i specifies that performing one or more of a specified set of sequences more than 80% of the time spent on a workflow is bad.

The specified interaction patterns 1824 can be provided to the ML engine 1804, as training data, for use in model building, as described below. In some implementations, the specified interaction patterns 1824 can be provided to the interaction log processor 1808. The interaction log processor 1808 can process interaction logs to locate interactions that match at least one specified interaction pattern 1824. The located interaction log entries that match at least one specified interaction pattern 1824 can be provided to the ML engine 1804, for model building (e.g., further learning), as described below.

As another example, an administrator can select, as training data and using the engine configuration application 1806, certain selected cases 1828 as being either good or bad (or a degree of satisfactory/unsatisfactory). That is, the administrator can manually select certain cases as ground truth for good or bad case results. The interaction log processor 1808 can locate interaction log entries associated with the selected cases and provide the located interaction log entries to the ML engine 1804. In some implementations, an administrator can, for example, using an interaction log browser tool, select certain interaction log entries as either being associated with a good or bad case result. Interaction log entries selected by an administrator can be provided to the ML engine 1804.

A model builder 1830 of the ML engine 1804 can build interaction models, including the interaction model 1820. The model builder 1830 can build the interaction model 1820 by using ML to learn which patterns of representative behavior correlate to either a good or bad case result. A good or bad case result can be a case for which case handling was efficient, inefficient, high quality, low quality, etc. The ML engine 1804 (and the model builder 1830) can use different types of ML, including neural networks, regression, supervised and/or unsupervised learning, or other ML approaches. In some implementations, different types of ML is used, and prediction and performance results of the different ML approaches can be compared. One of the ML approaches may be selected based on performance, or different ML approaches may be used simultaneously (e.g., different ML approaches may be used for different types of inputs).

The model builder 1830 can use training data provided by the engine configuration application 1806 or by another input source. For example, the model builder 1830 can analyze interaction log entries received from the interaction log processor 1808 or an administrator that have been flagged as corresponding to a good or bad case result, to learn interaction patterns that lead to a good or bad case result. As mentioned above, interaction log entries received from the interaction log processor 1808 can be interaction log entries associated with the case result criteria 1818, the model-user selections 1822, or the case selections 1828. The model builder 1830 can group interaction log entries that are associated with a particular case result (e.g., good or bad) and look for and identify commonalities in the grouped interaction log entries for a specific case result to determine specific interaction patterns or behaviors that happen within those cases that are most corroborated with a good or bad result. Learned patterns learned by the model builder 1830 can be similar to the interaction patterns 1826 specified by an administrator, for example. The model builder 1830 can also process all interaction log entries in the interaction data 1810 for an interaction pattern, to further learn an effect of an interaction pattern and/or to increase a confidence level of a particular interaction pattern indicating a particular case result, by locating all interaction log entries that include a certain interaction pattern and determining which interaction patterns are most indicative of leading to a particular case result.

The model builder 1830 can also build or expand the interaction model 1820 using the specified interaction patterns 1824. For example, in response to receiving the specified interaction patterns 1824, the model builder 1830 can include (at least initially) the specified interaction patterns 1824 in the interaction model 1820. The model builder 1830 can also use ML to learn other patterns based on the specified interaction patterns 1824. For example, the model builder 1830 can analyze interaction log entries that include at least one specified interaction pattern 1824, to learn other interaction patterns that may indicate a particular case result. Learned patterns learned by the model builder 1830 and included in the interaction model 1820 can represent specific moments in case handling that may be a “tipping point” for determining whether a case result may be good or bad.

In some implementations, the interaction model 1820 is specific to a particular workflow and/or a particular representative. Other interaction models can be specific to other workflows and/or other representatives. Interaction models specific to a representative can represent behavior of that representative. For example, the model builder 1830 may learn that when a first representative performs a certain sequence of interaction(s) during a certain type of workflow, a particular case type result (good or bad) often occurs, but when a second, different representative performs that same sequence of interaction(s) for that workflow, a different case type result occurs, or, as another example, the sequence of interaction(s) is not predictive of a case type result when performed by the second representative.

An interaction analyzer 1832 of the ML engine 1804 can analyze interaction data (e.g., either historical or real-time interaction data) and compare the interaction data to an appropriate interaction model 1820. For example, when analyzing historical interactions, the interaction analyzer 1832 can analyze historical interactions for a particular representative, team, or site for a particular workflow by comparing the historical interactions for the particular representative, team, or site to an interaction model 1820 for the workflow. When analyzing real-time interactions, the interaction analyzer 1832 can determine or identify the representative and a workflow being performed by the representative, and compare the real-time interactions to an interaction model specific to the workflow (and possibly specific to the representative). The interaction analyzer 1832 can determine interaction feedback 1833 for the representative, team, or site, based on comparing interaction data to the interaction model 1820. The interaction feedback 1833, whether presented in real time or in a later reporting format, can be used for training representatives to use best processes and tools, to avoid known mistakes, to follow best known steps, to be more efficient, and/or to produce better quality results based on prescribed or learned patterns.

Interaction feedback 1833 can be provided to an action engine 1834, which can perform various types of actions based on the interaction feedback 1833. Although shown as being included in the ML engine 1804, the action engine 1834 can be a separate engine. For instance, for real-time interaction data analyzing, the interaction feedback 1833 can be real-time feedback 1836 that can be provided, for example, to a representative device 1838 and/or a supervisor device 1840. Real-time feedback 1836 can include affirmative communications and suggestions for improved behavior. For some types of interaction feedback 1833, the action engine 1884 may perform one or more automatic actions 1842. The action engine 1834 can also generate different types of reports 1844, which can be provided to the representative device 1838 and/or the supervisor device 1840 after a time period or case session in which the interactions are analyzed. In some implementations, the action engine 1834 provides other action data 1846, that can be provided to and consumed by other action performers 1848. Real-time feedback 1836, automatic actions 1842, reporting, and the other action performers 1848 are each described in more detail below.

The real-time feedback 1836 can take the form of written, verbal, or symbolic instruction sets comprised of any number of recommended actions, that can be presented in real time to direct representative behavior. The interaction analyzer 1832 can, for example, determine that a case or case session may result in a negative outcome, and determine recommended actions that are likely to prevent the negative outcome. Accordingly, when the representative acts on the recommended actions as a next best course of action, the predicted negative outcome can be avoided. The real-time feedback 1836 can serve as interventions for preventing undesirable case outcomes such as low quality or low efficiency. In addition or alternatively to being presented on the representative device 1838, real-time feedback 1836 can be presented on a supervisor device 1840, for example, in a monitoring queue. For some cases, a supervisor can initiate an intervention, escalation, or change of action for the case.

The interaction analyzer 1832, when comparing interaction data to the interaction model 1820, can determine whether an undesired result is predicted to occur. In some cases, when no issue is predicted to occur, real-time affirmative feedback information can be generated, and presented to the representative as the real-time feedback 1836. For example, the interaction analyzer 1832 can determine, based on the interaction model 1820, that recent interactions are likely to result in a good case result and/or that current interactions match prescribed behavior. Accordingly, the real-time feedback 1836 can be presented to inform the representative that a good outcome is predicted and/or that the current behavior is following recommended guidelines.

The interaction analyzer 1832 can determine an issue or a predicted issue when comparing interaction data to the interaction model 1820. For example, the interaction analyzer can determine that recent behavior is not following prescribed behavior. As another example, the interaction analyzer 1832 can determine that recent representative behavior is not likely to lead to a desired case outcome. When the interaction analyzer 1832 determines an issue or a predicted issue, the interaction analyzer 1832 can determine behavior improvement recommendations to correct the issue or prevent the predicted issue, respectively. For example, the interaction analyzer 1832 can determine corrective actions that, if performed, will return the representative to a path of prescribed actions. As another example, the interaction analyzer 1832 can determine actions that, if taken, can correct a current path of actions that may lead to an undesirable result and prevent the undesirable result. The interaction analyzer 1832 can determine a next best action (or set of actions) for the representative to perform to increase a probability of a good case outcome.

As mentioned, the interaction model 1820 may be a personal model for the representative. Accordingly, the real-time feedback 1836, or lack of a generation of interaction feedback 1833, may be based on comparing the current/recent interactions to the personalized interaction model. For example, a first representative may not be given a recommended change-of-course instruction after performing interaction X, because the interaction model for the first representative indicates that interaction X does not lead to a bad case outcome when performed by the first representative. However, other representatives may be given real-time feedback 1836 in the form of behavior suggestions if they perform interaction X. The first representative may have learned a specific shortcut, for example, that works for the first representative but may not work successfully for representatives in general.

Examples of real-time feedback 1836 can be instructions that take on the form of 1) “You haven't performed interaction X yet, please do interaction X”; 2) “You performed interaction X when you shouldn't have, please perform interaction sequence <Y,Z>”; or 3) “You performed interaction X, now please perform interactions Y and Z”. These examples are meant to be illustrative of processing of the interaction analyzer 1832 determining an issue and communicating a recommendation. Actual wording may be tailored for the representative to best inform the representative how to perform a next best action.

In general, the real-time feedback 1836 can include instructions for performing the determined corrective or preventative actions. The real-time feedback 1836 can include personalized improvement recommendations that can be presented to the representative directly within the context of a task they are actively performing. In some cases, the real-time feedback 1836 can inform the representative of a misstep in prescribed actions, or an interaction sequence that led to a likelihood of a bad future case outcome. In some cases, the real-time feedback 1836 can instruct the user to perform certain actions, and that if not performed within a certain time window, the system will perform the recommended actions on behalf of the representative (e.g. as the automatic actions 1842).

The interaction feedback 1833 can be automatically used as input to the action engine 1834 for automatically performing actions 1842 on behalf of the representative, to implement the interaction feedback 1833. The action engine 1834 can notify the representative (e.g., as real-time feedback 1836) of what actions were automatically performed. In some cases, actions that may be automatically performed are defined by an administrator using action rules 1850. The action rules 1850 can specify certain actions to take if certain interaction patterns are detected, for example. In some cases, the learned coaching engine 1802 interfaces with other system(s), such as one or more of the other action performers, using an API 1852, to have actions automatically performed. The action data 1846 can be sent to one of the other action performers 1848 using the API 1852. The action data 1846 can describe which action(s) to perform, based on determined interaction feedback 1833. The other action performer 1848 can receive the action data 1846, using the API 1852, and perform the requested action(s). The other action performer 1848 can be a different application running on the representative device 1838, for example.

The reports 1844 can include after-the-fact analysis and recommendation for coaching opportunities, for different representatives, teams, or sites, for example. Representative-level recommendations can include recommendations such as: 1) “You generally or often perform interaction X before performing interaction Y—alternatively, performing interaction Z before interaction Y is preferred”; 2) “You have responded affirmatively to the following presented recommendations, here are the resultant changes in case outcomes based on those actions”; or 3) “You responded affirmatively to these 10 recommendations but did not respond to these 4 recommendations—here are the resultant difference in case outcomes when responding vs. not responding.”

In response to analyzing interaction data for different teams or sites, the reports 1844 can include aggregate team or site level recommendations, for example, which can be similar to the recommendations above. Other team or site recommendations may be similar to: 1) “Agents on team X generally do action or sequence Y, which often leads to undesirable results, here is recommended alternative behavior as a team wide recommendation: . . . ”; or 2) “Agents at site Y affirmatively respond to suggestions at less than a desired 90% level, site wide communication is recommended.” Other types of representative, team, or site recommendations can be included in the reports 1844, as appropriate. The reports 1844 can also include interaction or case metrics 1854 that may have been generated by the interaction log processor. For example, the interaction log processor can, for instance after or as part of determining which interaction log entries match the case result criteria 1818 or specified interaction patterns 1824, determine which representatives are associated with those determined interaction log entries. The representatives can be included in a report 1844 (e.g., as “best” (or “worst”) representatives.

The reports 1844 and/or the other action data 1846 can be provided to the other action performers 1848 for performing (either as manual or automated actions), various other types of actions, such as personnel actions 1856, training actions 1858, or tool-change actions 1860. Personnel actions 1856 can include generation and allocation of awards or recognition, for representatives selected or identified as model representatives. Training actions 1858 can include recommendations for training representatives in general, based on determining how the model representatives have been trained and recommending modeling of training of other representatives based on how the model representatives were trained. Training actions 1858 can include actions taken to train users how to interact with the learned coaching engine 1802 (specifically how to interact with and respond to the real-time feedback 1836). Tool change actions 1860 can include recommendations for installing or reconfiguring different tools, based on interaction patterns that have been determined to correspond to good or bad case outcomes. For example, the ML engine 1804 may learn that certain patterns performed using a first tool lead to good outcomes, but that the first tool is not yet available team wide or site wide, for instance. A tool change recommendation can be to further deploy the first tool. As another example, the ML engine 1804 may learn that a certain interaction sequence performed with a second tool leads to bad outcomes, even though a third tool may be a preferred tool to use for performing a recommended, alternative interaction sequence. Accordingly, a tool change recommendation can be to remove or restrict access to the second tool.

The action engine 1834 can record various information about actions and recommendations, such whether or not a representative performs a recommended action, which actions were performed automatically by the action engine 1834 or by one of the other action performers 1848, how and when recommendations are presented, etc. Additionally, the time/interaction tracker 1816 can continue to record the remainder of the representative's actions for the case session (and possibly other case sessions), until a case outcome is eventually recorded.

A learning feedback engine 1862 can analyze information about recorded actions, recommendations, deviations from recommendations, accepting or ignoring of recommendations, and other information and can update the interaction model 1820 (or instruct the model builder 1830 to update the interaction model 1820) as part of a ML feedback loop. For example, case results can be analyzed with respect to whether certain recommendations regarding certain interaction patterns were followed or not followed, to determine what effect following or not following certain recommendations may have had on a case result. For example, if certain recommendations were generally followed but did not result in an expected effect on case outcome, those types of recommendations may be made less in the future, or not at all, or may be made in an adjusted manner. As another example, if a certain deviation from a recommendation occurred above a certain frequency with a positive effect on case outcomes, the deviation can be factored into the interaction model 1820 to be considered for future recommendations. Additionally, a tailoring may be performed for how and when recommendations are presented, based on which methods of presenting recommendations result in a highest recommendation acceptance rate.

As another example, the learning feedback engine 1862 can verify previously received training inputs, such as the model-user selections 1822 and/or specified interaction patterns 1824 that were associated by an administrator with a good or bad case outcome. The learning feedback engine 1862 can analyze whether a model representative or an interaction pattern flagged as corresponding to a good result actually, over time, correspond to good results. The learning feedback engine 1862 can generate learning feedback information 1864 that can be presented to an administrator in the engine configuration application 1806, as informative information and/or as recommendations for updating training data, for example.

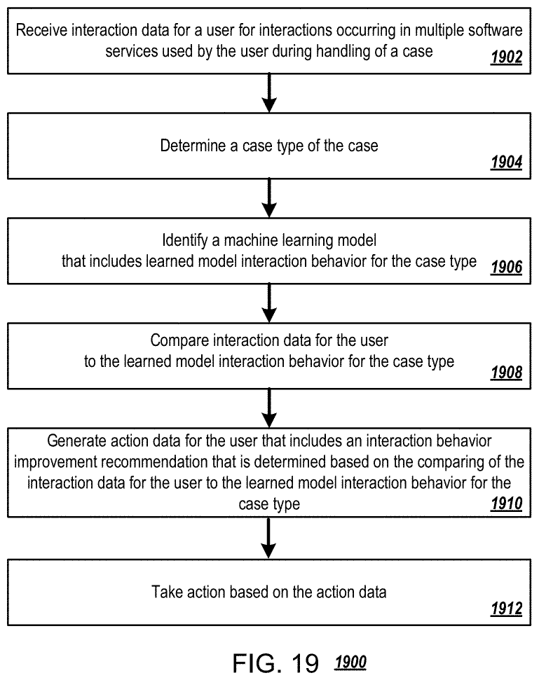

FIG. 19 is a flowchart of a method 1900 for automatic generative learned process coaching in a digital environment. For example, the learned coaching engine 1802 can be used to perform the method 1900. For clarity of presentation, the description that follows generally describes method 1900 in the context of the other figures in this description. However, it will be understood that method 1900 can be performed, for example, by any suitable system, environment, software, and hardware, or a combination of systems, environments, software, and hardware, as appropriate. In some implementations, various steps of method 1900 can be run in parallel, in combination, in loops, or in any order.

At 1902, interaction data is received for a user for interactions occurring in multiple software services used by the user during handling of a case. The received interaction data can be historical interaction data or real-time interaction data.

At 1904, a case type of the case is determined.

At 1906, a machine learning model is identified that includes learned model interaction behavior for the case type. The machine learning model can be trained on one or more of specified interaction patterns that are specified as correlating to either a good case result or a bad case result for the case type, ground truth interaction data associated with cases that have been identified as having either a good case result or a bad case result, or ground truth interaction data associated with model users who have been identified as model user performers for the case type.

At 1908, the interaction data for the user is compared to the learned model interaction behavior for the case type. When the interaction data is real-time interaction data for handling of a current case, a result of the comparison can be a determination that the real-time interaction data is a predictor of a negative case outcome for the current case. As another example, a result of the comparison can be that the real-time interaction data does not match specific interaction behavior patterns that have been identified as prescribed behavior for the case type.

At 1910, action data is generated for the user. The action data includes an interaction behavior improvement recommendation that is determined based on the comparing of the interaction data for the user to the learned model interaction behavior for the case type. When the received interaction data is real-time interaction data, the behavior improvement recommendation can be a real-time recommendation for performing one or more interactions for handling of the current case that are predicted by the machine learning model to have a positive effect on the case result for the case.

At 1920, action is taken based on the action data. When the received interaction data is real-time interaction data, taking action can include presenting the behavior improvement recommendation to the user. As another example, taking action can include automatically performing one or more interactions on behalf of the user that have been predicted by the machine learning model to have a positive effect on the case outcome for the case. When the received interaction data is historical interaction data, taking action can include including the behavior improvement recommendation in a report and providing the report to a user or a supervisor of the user.

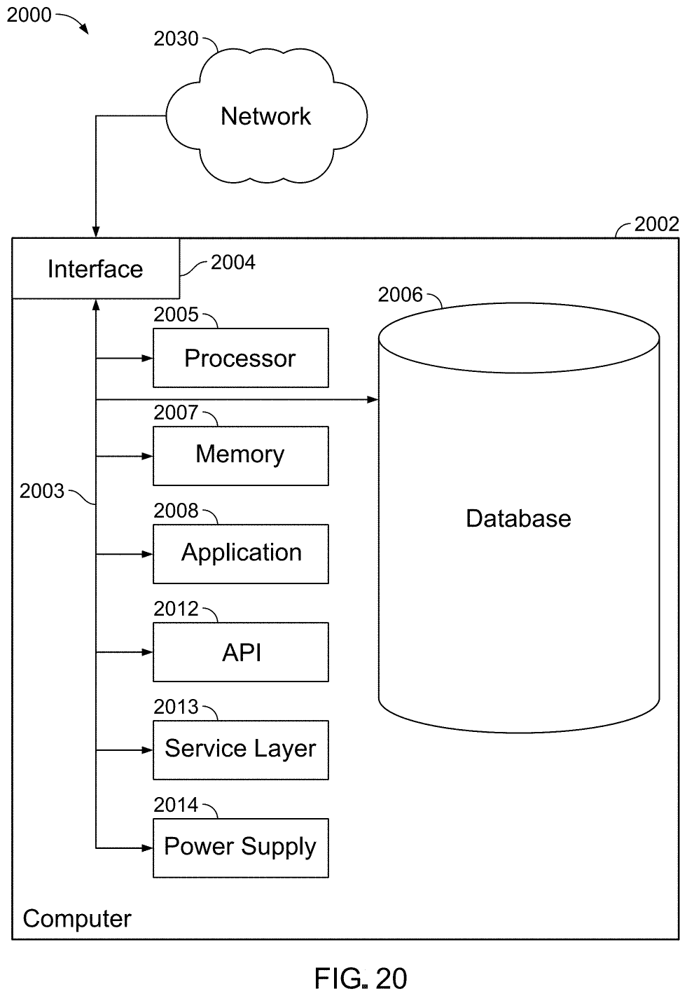

FIG. 20 is a block diagram of an example computer system 2000 used to provide computational functionalities associated with described algorithms, methods, functions, processes, flows, and procedures described in the present disclosure, according to some implementations of the present disclosure. The illustrated computer 2002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 2002 can include input devices such as keypads, keyboards, and touch screens that can accept user information. Also, the computer 2002 can include output devices that can convey information associated with the operation of the computer 2002. The information can include digital data, visual data, audio information, or a combination of information. The information can be presented in a graphical user interface (UI) (or GUI).

The computer 2002 can serve in a role as a client, a network component, a server, a database, a persistency, or components of a computer system for performing the subject matter described in the present disclosure. The illustrated computer 2002 is communicably coupled with a network 2030. In some implementations, one or more components of the computer 2002 can be configured to operate within different environments, including cloud-computing-based environments, local environments, global environments, and combinations of environments.

At a top level, the computer 2002 is an electronic computing device operable to receive, transmit, process, store, and manage data and information associated with the described subject matter. According to some implementations, the computer 2002 can also include, or be communicably coupled with, an application server, an email server, a web server, a caching server, a streaming data server, or a combination of servers.

The computer 2002 can receive requests over network 2030 from a client application (for example, executing on another computer 2002). The computer 2002 can respond to the received requests by processing the received requests using software applications. Requests can also be sent to the computer 2002 from internal users (for example, from a command console), external (or third) parties, automated applications, entities, individuals, systems, and computers.

Each of the components of the computer 2002 can communicate using a system bus 2003. In some implementations, any or all of the components of the computer 2002, including hardware or software components, can interface with each other or the interface 2004 (or a combination of both) over the system bus 2003. Interfaces can use an application programming interface (API) 2012, a service layer 2013, or a combination of the API 2012 and service layer 2013. The API 2012 can include specifications for routines, data structures, and object classes. The API 2012 can be either computer-language independent or dependent. The API 2012 can refer to a complete interface, a single function, or a set of APIs.

The service layer 2013 can provide software services to the computer 2002 and other components (whether illustrated or not) that are communicably coupled to the computer 2002. The functionality of the computer 2002 can be accessible for all service consumers using this service layer. Software services, such as those provided by the service layer 2013, can provide reusable, defined functionalities through a defined interface. For example, the interface can be software written in JAVA, C++, or a language providing data in extensible markup language (XML) format. While illustrated as an integrated component of the computer 2002, in alternative implementations, the API 2012 or the service layer 2013 can be stand-alone components in relation to other components of the computer 2002 and other components communicably coupled to the computer 2002. Moreover, any or all parts of the API 2012 or the service layer 2013 can be implemented as child or sub-modules of another software module, enterprise application, or hardware module without departing from the scope of the present disclosure.

The computer 2002 includes an interface 2004. Although illustrated as a single interface 2004 in FIG. 20, two or more interfaces 2004 can be used according to particular needs, desires, or particular implementations of the computer 2002 and the described functionality. The interface 2004 can be used by the computer 2002 for communicating with other systems that are connected to the network 2030 (whether illustrated or not) in a distributed environment. Generally, the interface 2004 can include, or be implemented using, logic encoded in software or hardware (or a combination of software and hardware) operable to communicate with the network 2030. More specifically, the interface 2004 can include software supporting one or more communication protocols associated with communications. As such, the network 2030 or the interface's hardware can be operable to communicate physical signals within and outside of the illustrated computer 2002.

The computer 2002 includes a processor 2005. Although illustrated as a single processor 2005 in FIG. 20, two or more processors 2005 can be used according to particular needs, desires, or particular implementations of the computer 2002 and the described functionality. Generally, the processor 2005 can execute instructions and can manipulate data to perform the operations of the computer 2002, including operations using algorithms, methods, functions, processes, flows, and procedures as described in the present disclosure.

The computer 2002 also includes a database 2006 that can hold data for the computer 2002 and other components connected to the network 2030 (whether illustrated or not). For example, database 2006 can be an in-memory, conventional, or a database storing data consistent with the present disclosure. In some implementations, database 2006 can be a combination of two or more different database types (for example, hybrid in-memory and conventional databases) according to particular needs, desires, or particular implementations of the computer 2002 and the described functionality. Although illustrated as a single database 2006 in FIG. 20, two or more databases (of the same, different, or combination of types) can be used according to particular needs, desires, or particular implementations of the computer 2002 and the described functionality. While database 2006 is illustrated as an internal component of the computer 2002, in alternative implementations, database 2006 can be external to the computer 2002.

The computer 2002 also includes a memory 2007 that can hold data for the computer 2002 or a combination of components connected to the network 2030 (whether illustrated or not). Memory 2007 can store any data consistent with the present disclosure. In some implementations, memory 2007 can be a combination of two or more different types of memory (for example, a combination of semiconductor and magnetic storage) according to particular needs, desires, or particular implementations of the computer 2002 and the described functionality. Although illustrated as a single memory 2007 in FIG. 20, two or more memories 2007 (of the same, different, or combination of types) can be used according to particular needs, desires, or particular implementations of the computer 2002 and the described functionality. While memory 2007 is illustrated as an internal component of the computer 2002, in alternative implementations, memory 2007 can be external to the computer 2002.

The application 2008 can be an algorithmic software engine providing functionality according to particular needs, desires, or particular implementations of the computer 2002 and the described functionality. For example, application 2008 can serve as one or more components, modules, or applications. Further, although illustrated as a single application 2008, the application 2008 can be implemented as multiple applications 2008 on the computer 2002. In addition, although illustrated as internal to the computer 2002, in alternative implementations, the application 2008 can be external to the computer 2002.

The computer 2002 can also include a power supply 2014. The power supply 2014 can include a rechargeable or non-rechargeable battery that can be configured to be either user- or non-user-replaceable. In some implementations, the power supply 2014 can include power-conversion and management circuits, including recharging, standby, and power management functionalities. In some implementations, the power-supply 2014 can include a power plug to allow the computer 2002 to be plugged into a wall socket or a power source to, for example, power the computer 2002 or recharge a rechargeable battery.

There can be any number of computers 2002 associated with, or external to, a computer system containing computer 2002, with each computer 2002 communicating over network 2030. Further, the terms “client,” “user,” and other appropriate terminology can be used interchangeably, as appropriate, without departing from the scope of the present disclosure. Moreover, the present disclosure contemplates that many users can use one computer 2002 and one user can use multiple computers 2002.

Described implementations of the subject matter can include one or more features, alone or in combination. For example, in a first implementation, a computer-implemented method includes the actions of: receiving interaction data for a user for interactions occurring in multiple software services used by the user during handling of a case; determining a case type of the case; identifying a machine learning model that includes learned model interaction behavior for the case type; comparing interaction data for the user to the learned model interaction behavior for the case type; generating action data for the user, wherein the action data comprises an interaction behavior improvement recommendation that is determined based on the comparing of the interaction data for the user to the learned model interaction behavior for the case type; and taking action based on the action data.

In a second implementation, a non-transitory, computer-readable medium stores one or more instructions executable by a computer system to perform operations including: receiving interaction data for a user for interactions occurring in multiple software services used by the user during handling of a case; determining a case type of the case; identifying a machine learning model that includes learned model interaction behavior for the case type; comparing interaction data for the user to the learned model interaction behavior for the case type; generating action data for the user, wherein the action data comprises an interaction behavior improvement recommendation that is determined based on the comparing of the interaction data for the user to the learned model interaction behavior for the case type; and taking action based on the action data.

In a third implementation, a system comprises one or more computers and one or more storage devices on which are stored instructions that are operable, when executed by the one or more computers, to cause the one or more computers to perform operations. The operations include: receiving interaction data for a user for interactions occurring in multiple software services used by the user during handling of a case; determining a case type of the case; identifying a machine learning model that includes learned model interaction behavior for the case type; comparing interaction data for the user to the learned model interaction behavior for the case type; generating action data for the user, wherein the action data comprises an interaction behavior improvement recommendation that is determined based on the comparing of the interaction data for the user to the learned model interaction behavior for the case type; and taking action based on the action data.

The foregoing and other described implementations can each, optionally, include one or more of the following features:

A first feature, combinable with any of the following features, wherein the machine learning model is trained on specified interaction patterns that are specified as correlating to either a good case result or a bad case result for the case type.

A second feature, combinable with any of the previous or following features, wherein the machine learning model is trained using ground truth interaction data associated with cases that have been identified as having either a good case result or a bad case result.

A third feature, combinable with any of the previous or following features, wherein the machine learning model is trained using ground truth interaction data associated with model users who have been identified as model user performers for the case type.

A fourth feature, combinable with any of the previous or following features, wherein the received interaction data comprises historical interaction data and wherein taking action comprises including the interaction behavior improvement recommendation in a report.

A fifth feature, combinable with any of the previous or following features, wherein: the received interaction data comprises real-time interaction data for handling of a current case; and the behavior improvement recommendation is a real-time recommendation for performing one or more interactions for handling of the current case that are predicted by the machine learning model to have a positive effect on the case result for the case.

A sixth feature, combinable with any of the previous or following features, wherein: the received interaction data comprises real-time interaction data for handling of a current case; and taking action comprises automatically performing one or more interactions on behalf of the user for handling the case, wherein the one or more interactions are predicted by the machine learning model to have a positive effect on the case result for the case.

A seventh feature, combinable with any of the previous or following features, wherein the machine learning model is user-specific for the user and the case type and is trained based on past interactions of the user.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving interaction data for a user for interactions occurring in multiple software services used by the user during handling of a case;
determining a case type of the case;
identifying a machine learning model that includes learned model interaction behavior for the case type;
comparing interaction data for the user to the learned model interaction behavior for the case type;
generating action data for the user, wherein the action data comprises an interaction behavior improvement recommendation that is determined based on the comparing of the interaction data for the user to the learned model interaction behavior for the case type; and
taking action based on the action data.

2. The computer-implemented method of claim 1, wherein the machine learning model is trained on specified interaction patterns that are specified as correlating to either a good case result or a bad case result for the case type.

3. The computer-implemented method of claim 1, wherein the machine learning model is trained using ground truth interaction data associated with cases that have been identified as having either a good case result or a bad case result.

4. The computer-implemented method of claim 1, wherein the machine learning model is trained using ground truth interaction data associated with model users who have been identified as model user performers for the case type.

5. The computer-implemented method of claim 1, wherein the received interaction data comprises historical interaction data and wherein taking action comprises including the interaction behavior improvement recommendation in a report.

6. The computer-implemented method of claim 1, wherein:
the received interaction data comprises real-time interaction data for handling of a current case; and
the behavior improvement recommendation is a real-time recommendation for performing one or more interactions for handling of the current case that are predicted by the machine learning model to have a positive effect on the case result for the case.

7. The computer-implemented method of claim 1, wherein:
the received interaction data comprises real-time interaction data for handling of a current case; and
taking action comprises automatically performing one or more interactions on behalf of the user for handling the case, wherein the one or more interactions are predicted by the machine learning model to have a positive effect on the case result for the case.

8. The computer-implemented method of claim 1, wherein the machine learning model is user-specific for the user and the case type and is trained based on past interactions of the user.

9. One or more computer-readable storage media encoded with instructions that, when executed by one or more computers, cause the one or more computers to perform operations comprising:
receiving interaction data for a user for interactions occurring in multiple software services used by the user during handling of a case;
determining a case type of the case;
identifying a machine learning model that includes learned model interaction behavior for the case type;
comparing interaction data for the user to the learned model interaction behavior for the case type;
generating action data for the user, wherein the action data comprises an interaction behavior improvement recommendation that is determined based on the comparing of the interaction data for the user to the learned model interaction behavior for the case type; and
taking action based on the action data.

10. The computer-readable storage media of claim 9, wherein the machine learning model is trained on specified interaction patterns that are specified as correlating to either a good case result or a bad case result for the case type.

11. The computer-readable storage media of claim 9, wherein the machine learning model is trained using ground truth interaction data associated with cases that have been identified as having either a good case result or a bad case result.

12. The computer-readable storage media of claim 9, wherein the machine learning model is trained using ground truth interaction data associated with model users who have been identified as model user performers for the case type.

13. The computer-readable storage media of claim 9, wherein the received interaction data comprises historical interaction data and wherein taking action comprises including the interaction behavior improvement recommendation in a report.

14. The computer-readable storage media of claim 9, wherein:
the received interaction data comprises real-time interaction data for handling of a current case; and
the behavior improvement recommendation is a real-time recommendation for performing one or more interactions for handling of the current case that are predicted by the machine learning model to have a positive effect on the case result for the case.

15. A system comprising:
one or more computers and one or more storage devices on which are stored instructions that are operable, when executed by the one or more computers, to cause the one or more computers to perform operations comprising:
receiving interaction data for a user for interactions occurring in multiple software services used by the user during handling of a case;
determining a case type of the case;
identifying a machine learning model that includes learned model interaction behavior for the case type;
comparing interaction data for the user to the learned model interaction behavior for the case type;
generating action data for the user, wherein the action data comprises an interaction behavior improvement recommendation that is determined based on the comparing of the interaction data for the user to the learned model interaction behavior for the case type; and
taking action based on the action data.

16. The system of claim 15, wherein the machine learning model is trained on specified interaction patterns that are specified as correlating to either a good case result or a bad case result for the case type.

17. The system of claim 15, wherein the machine learning model is trained using ground truth interaction data associated with cases that have been identified as having either a good case result or a bad case result.

18. The system of claim 15, wherein the machine learning model is trained using ground truth interaction data associated with model users who have been identified as model user performers for the case type.

19. The system of claim 15, wherein the received interaction data comprises historical interaction data and wherein taking action comprises including the interaction behavior improvement recommendation in a report.

20. The system of claim 15, wherein:
the received interaction data comprises real-time interaction data for handling of a current case; and
the behavior improvement recommendation is a real-time recommendation for performing one or more interactions for handling of the current case that are predicted by the machine learning model to have a positive effect on the case result for the case.
